(19) United States
(12) Patent Application Publication
(10) Pub. No.: US 2016/0252712 A1
(43) Pub. Date: Sep. 1, 2016

(54) ZOOM LENS SYSTEM, INTERCHANGEABLE LENS DEVICE, AND CAMERA SYSTEM

(71) Applicant: Panasonic Intellectual Property Management Co., Ltd., Osaka (JP)

(72) Inventors: TSUNEO UCHIDA, Chiba (JP); MASAFUMI SUEYOSHI, Kanagawa (JP); YOSHIO MATSUMURA, Osaka (JP)

(21) Appl. No.: 15/150,245

(22) Filed: May 9, 2016

Related U.S. Application Data
(63) Continuation of application No. PCT/JP2015/001465, filed on Mar. 17, 2015.

(30) Foreign Application Priority Data
Mar. 28, 2014 (JP) 2014-068194

(51) Int. Cl. G02B 15/20; H04N 5/225; G02B 13/00; G02B 27/64; G03B 17/14

(52) U.S. Cl. CPC G02B 15/20; G02B 27/646; G03B 17/14; G02B 13/009; H04N 5/2254

(57) ABSTRACT

Provided is a zoom lens system including, from an object side to an image side: a first lens group having positive power; a second lens group having negative power; and a subsequent lens group including at least three lens groups, wherein the subsequent lens group includes two or more positive lens groups, the first lens group includes two or less lens elements, the second lens group includes four or more lens elements, the first lens group, the second lens group and a most image side lens group which disposed closest to the image side move with respect to an image plane in zooming from a wide angle end to a telephoto end, and a lens group disposed between the third lens group and an image plane is moved along an optical axis as a focusing lens group in focusing from an infinity in-focus condition to a close-object in-focus condition.

### BACKGROUND

1. Technical Field

The present disclosure relates to a zoom lens system which is compact and excellent in focusing performance, and an interchangeable lens device and a camera system which include the zoom lens system.

2. Description of the Related Art

The lens system disclosed in Unexamined Japanese Patent Publication No. 2012-212106 has positive-negative-positive-negative-positive five-group structure including an image blur compensation lens group that is a part of a second lens group or a part of a third lens group and that moves in the vertical direction relative to an optical axis to optically compensate image blur. This publication also discloses the zoom lens system characterized in that each of a first lens group and a second lens group moves relative to an image plane in zooming from a wide angle end to a telephoto end upon imaging.

The lens system disclosed in Unexamined Japanese Patent Publication No. 2005-107273 has positive-negative-positive-positive-positive configuration. In zooming from a wide angle end condition to a telephoto end condition, a space between a first lens group and a second lens group is increased, a space between the second lens group and a third lens group is decreased, a space between the third lens group and a fourth lens group is decreased, a space between the fourth lens group and a fifth lens group is increased, and the third lens group and the fourth lens group move toward an object side. This publication also discloses the zoom lens system in which the fourth lens group includes, in order from the object side, a first doublet including a first positive lens and a first negative lens and a second doublet including a second negative lens and a second positive lens.

Unexamined Japanese Patent Publication No. 2006-251462 discloses a zoom lens system including lens groups having positive-negative-positive-negative-positive-negative power configurations, wherein fourth lens group GR4 described above moves in an optical axis direction to perform focusing.

### SUMMARY

The present disclosure is a zoom lens system including, in order from an object side to an image side: a first lens group having positive power; a second lens group including four or more lens elements and having negative power; and a subsequent lens group including a third lens group and having at least four lens groups. And, in zooming from a wide angle end to a telephoto end, the first lens group, the second lens group and a most image side lens group which disposed closest to the image side move to the object side, a focusing lens group is provided closer to the image side than the third group, and the subsequent group includes at least two or more positive lens groups. Moreover, the zoom lens system satisfied the following three conditions: 0.1<α2f/W<4.0, 2.7<G1f/Wf<14.0 and 2.0<|G1f/G2f|<8.0, where Wf is a focal length of an entire system at the wide angle end, α2f is a focal length of a lens group having a second highest power out of the two or more positive lens groups included in the subsequent lens group, G1f is a focal length of the first lens group, and G2f is a focal length of the second lens group.

The present disclosure is also an interchangeable lens device including: the zoom lens system; and a lens mount section that is connectable to a camera body including an image sensor which receives an optical image formed by the zoom lens system and converts the optical image into an electric image signal.

The present disclosure is also a camera system including: an interchangeable lens device including the zoom lens system; and a camera body that is detachably connected to the interchangeable lens device through a camera mount section and includes an image sensor which receives an optical image formed by the zoom lens system and converts the received image into an electric image signal.

### BRIEF DESCRIPTION OF DRAWINGS

FIG. 1 is a lens arrangement diagram of a zoom lens system in an infinity in-focus condition according to a first exemplary embodiment (Numerical Example 1);

FIG. 2 is an axial aberration diagram of the zoom lens system in an infinity in-focus condition according to the first exemplary embodiment;

FIG. 3 is a lateral aberration diagram of the zoom lens system at a telephoto end in a basic condition in which an image blur compensation is not performed and in an image blur compensation condition according to the first exemplary embodiment;

FIG. 4 is a lens arrangement diagram of a zoom lens system in an infinity in-focus condition according to a second exemplary embodiment (Numerical Example 2);

FIG. 5 is an axial aberration diagram of the zoom lens system in an infinity in-focus condition according to the second exemplary embodiment;

FIG. 6 is a lateral aberration diagram of the zoom lens system at a telephoto end in a basic condition in which an image blur compensation is not performed and in an image blur compensation condition according to the second exemplary embodiment;

FIG. 7 is a lens arrangement diagram of a zoom lens system in an infinity in-focus condition according to a third exemplary embodiment (Numerical Example 3);

FIG. 8 is an axial aberration diagram of the zoom lens system in an infinity in-focus condition according to the third exemplary embodiment;

FIG. 9 is a lateral aberration diagram of the zoom lens system at a telephoto end in a basic condition in which an image blur compensation is not performed and in an image blur compensation condition according to the third exemplary embodiment;

FIG. 10 is a lens arrangement diagram of a zoom lens system in an infinity in-focus condition according to a fourth exemplary embodiment (Numerical Example 4);

FIG. 11 is an axial aberration diagram of the zoom lens system in an infinity in-focus condition according to the fourth exemplary embodiment;

FIG. 12 is a lateral aberration diagram of the zoom lens system at a telephoto end in a basic condition in which an image blur compensation is not performed and in an image blur compensation condition according to the fourth exemplary embodiment;

FIG. 13 is a lens arrangement diagram of a zoom lens system in an infinity in-focus condition according to a fifth exemplary embodiment (Numerical Example 5);

FIG. 14 is an axial aberration diagram of the zoom lens system in an infinity in-focus condition according to the fifth exemplary embodiment;

FIG. 15 is a lateral aberration diagram of the zoom lens system at a telephoto end in a basic condition in which an image blur compensation is not performed and in an image blur compensation condition according to the fifth exemplary embodiment;

FIG. 16 is a lens arrangement diagram of a zoom lens system in an infinity in-focus condition according to a sixth exemplary embodiment (Numerical Example 6);

FIG. 17 is an axial aberration diagram of the zoom lens system in an infinity in-focus condition according to the sixth exemplary embodiment;

FIG. 18 is a lateral aberration diagram of the zoom lens system at a telephoto end in a basic condition in which an image blur compensation is not performed and in an image blur compensation condition according to the sixth exemplary embodiment; and

FIG. 19 is a schematic configuration diagram of a camera system according to a seventh exemplary embodiment.

### DETAILED DESCRIPTION

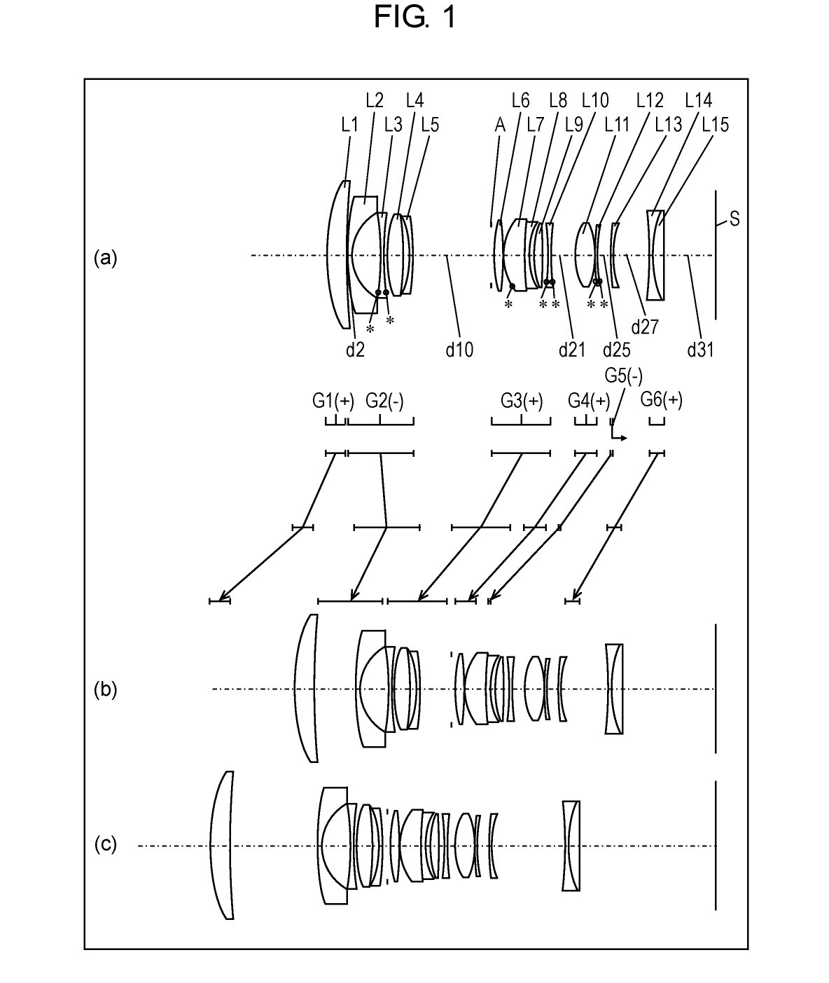

FIGS. 1, 4, 7, 10, 13, and 16 are each a lens arrangement diagram of a zoom lens system according to each of the first, second, third, fourth, fifth, and sixth exemplary embodiments, respectively, and each diagram illustrates the zoom lens system in an infinity in-focus condition. In each figure, (a) illustrates a lens configuration at a wide angle end (in the minimum focal length condition: focal length f_{W}), (b) illustrates a lens configuration at a middle position (in an intermediate focal length condition: focal length f_{M}=√(f_{W}*f_{T})), and (c) illustrates a lens configuration at a telephoto end (in the maximum focal length condition: focal length f_{T}). Further, in each figure, each arrow provided between (a) and (b) is a straight line obtained by linking the positions of a lens group at a wide angle end, a middle position, and a telephoto end in order from the top. In the part between the wide angle end and the middle position, and the part between the middle position and the telephoto end, the positions are connected simply with a straight line, and therefore this line does not indicate actual motion of each lens group. The direction of the arrow attached to each lens group in each figure indicates focusing from an infinity in-focus condition to a close-object in-focus condition. That is, the arrow indicates a moving direction from an infinity in-focus condition to a close-object in-focus condition in focusing.

In FIGS. 1, 4, 7, 10, 13, and 16, an asterisk “*” attached to a surface of a specific lens element indicates that the outer surface is aspheric. A symbol (+) or (−) attached to the reference symbol of each lens group corresponds to the sign of the power of each lens group. Further, a straight line located on the most right-hand side indicates the position of image plane S. Still further, aperture diaphragm A is provided in third lens group G3.

Each of the zoom lens systems according to the first to sixth exemplary embodiments includes, in order from an object side to an image side, a first lens group having positive power; a second lens group having negative power; and a subsequent group including at least three lens groups.

Each of the zoom lens systems according to the first to sixth exemplary embodiments includes an image blur compensation lens group which moves in a direction perpendicular to an optical axis to compensate an image blur caused by vibration of an optical system and which is configured by one lens element or a plurality of lens elements. Each of the zoom lens systems according to the first to sixth exemplary embodiments also includes a focusing lens group which moves along an optical axis in focusing from an infinity in-focus condition to a close-object in-focus condition and which includes one lens element or a plurality of lens elements.

### First Exemplary Embodiment

First lens group G1 includes first lens element L1 having a positive meniscus shape with a convex surface facing an object side.

Second lens group G2 includes, in order from the object side to an image side, second lens element L2 having a negative meniscus shape with a convex surface facing the object side, biconcave third lens element L3, biconvex fourth lens element L4, and fifth lens element L5 having a negative meniscus shape with a convex surface facing the image side. The surfaces of third lens element L3 at the object side and the image side are aspheric.

Third lens group G3 includes, in order from the object side to the image side, aperture diaphragm A, biconvex sixth lens element L6, seventh lens element L7 having a positive meniscus shape with a convex surface facing the object side, eighth lens element L8 having a negative meniscus shape with a convex surface facing the object side, biconvex ninth lens element L9, and biconcave tenth lens element L10. Seventh lens element L7 and eighth lens element L8 are cemented to each other. The surface of seventh lens element L7 at the object side and the surfaces of tenth lens element L10 at the object side and the image side are aspheric.

Fourth lens group G4 includes, in order from the object side to the image side, biconvex eleventh lens element L11 and twelfth lens element L12 having a negative meniscus shape with a convex surface facing the object side. The surfaces of twelfth lens element L12 at the object side and the image side are aspheric.

Fifth lens group G5 includes thirteenth lens element L13 having a negative meniscus shape with a convex surface facing the object side.

Sixth lens group G6 includes, in order from the object side to the image side, biconcave fourteenth lens element L14 and fifteenth lens element L15 having a positive meniscus shape with a convex surface facing the object side. Fourteenth lens element L14 and fifteenth lens element L15 are cemented to each other.

Each lens group moves in zooming from a wide angle end to a telephoto end such that the space between first lens group G1 and second lens group G2 is increased, the space between second lens group G2 and third lens group G3 is decreased, the space between third lens group G3 and fourth lens group G4 is decreased, the space between fourth lens group G4 and fifth lens group G5 is decreased, and the space between fifth lens group G5 and sixth lens group G6 is increased.

In focusing from an infinity in-focus condition to a close-object in-focus condition, fifth lens group G5 moves toward the image side along an optical axis. In addition, tenth lens element L10 which is a part of third lens group G3 moves in the direction perpendicular to the optical axis as an image blur compensation lens group in order to compensate image blur upon vibration of the lens system.

### Second Exemplary Embodiment

First lens group G1 includes, in order from an object side to an image side, first lens element L1 having a negative meniscus shape with a convex surface facing the object side and second lens element L2 having a positive meniscus shape with a convex surface facing the object side. First lens element L1 and second lens element L2 are cemented to each other.

Second lens group G2 includes, in order from the object side to the image side, third lens element L3 having a negative meniscus shape with a convex surface facing the object side, biconcave fourth lens element L4, biconvex fifth lens element L5, and sixth lens element L6 having a negative meniscus shape with a convex surface facing the image side. The surfaces of fourth lens element L4 at the object side and the image side are aspheric.

Third lens group G3 includes, in order from the object side to the image side, aperture diaphragm A, biconvex seventh lens element L7, eighth lens element L8 having a positive meniscus shape with a convex surface facing the object side, ninth lens element L9 having a negative meniscus shape with a convex surface facing the object side, biconvex tenth lens element L10, and biconcave eleventh lens element L11. Eighth lens element L8 and ninth lens element L9 are cemented to each other, and the surface of eighth lens element L8 at the object side and the surfaces of eleventh lens element L11 at the object side and the image side are aspheric.

Fourth lens group G4 includes, in order from the object side to the image side, biconvex twelfth lens element L12 and thirteenth lens element L13 having a negative meniscus shape with a convex surface facing the object side. The surfaces of thirteenth lens element L13 at the object side and the image side are aspheric.

Fifth lens group G5 includes fourteenth lens element L14 having a negative meniscus shape with a convex surface facing the object side.

Sixth lens group G6 includes, in order from the object side to the image side, biconcave fifteenth lens element L15 and sixteenth lens element L16 having a positive meniscus shape with a convex surface facing the object side. Fifteenth lens element L15 and sixteenth lens element L16 are cemented to each other.

Each lens group moves in zooming from a wide angle end to a telephoto end such that the space between first lens group G1 and second lens group G2 is increased, the space between second lens group G2 and third lens group G3 is decreased, the space between third lens group G3 and fourth lens group G4 is decreased, the space between fourth lens group G4 and fifth lens group G5 is decreased, and the space between fifth lens group G5 and sixth lens group G6 is increased.

In focusing from an infinity in-focus condition to a close-object in-focus condition, fifth lens group G5 moves toward the image side along an optical axis. In addition, eleventh lens element L11 which is a part of third lens group G3 moves in the direction perpendicular to the optical axis as an image blur compensation lens group in order to compensate image blur upon vibration of the optical system.

### Third Exemplary Embodiment

First lens group G1 includes first lens element L1 having a positive meniscus shape with a convex surface facing an object side.

Second lens group G2 includes, in order from an object side to an image side, second lens element L2 having a negative meniscus shape with a convex surface facing the object side, biconcave third lens element L3, biconvex fourth lens element L4, biconvex fifth lens element L5, and sixth lens element L6 having a negative meniscus shape with a convex surface facing the image side. The surfaces of third lens element L3 at the object side and the image side are aspheric.

Third lens group G3 includes, in order from the object side to the image side, aperture diaphragm A, biconvex seventh lens element L7, eighth lens element L8 having a negative meniscus shape with a convex surface facing the image side, biconvex ninth lens element L9, biconcave tenth lens element L10, eleventh lens element L11 having a negative meniscus shape with a convex surface facing the object side, and twelfth lens element L12 having a positive meniscus shape with a convex surface facing the object side. Ninth lens element L9 and tenth lens element L10 are cemented to each other. Eleventh lens element L11 and twelfth lens element L12 are cemented to each other. The surfaces of eighth lens element L8 at the object side and the image side and the surface of ninth lens element L9 at the object side are aspheric.

Fourth lens group G4 includes thirteenth lens element L13 having a negative meniscus shape with a convex surface facing the object side.

Fifth lens group G5 includes biconvex fourteenth lens element L14. The surfaces of fourteenth lens element L14 at the object side and the image side are aspheric.

Sixth lens group G6 includes fifteenth lens element L15 having a negative meniscus shape with a convex surface facing the object side.

Seventh lens group G7 includes, in order from the object side to the image side, biconcave sixteenth lens element L16 and seventeenth lens element L17 having a positive meniscus shape with a convex surface facing the object side. Sixteenth lens element L16 and seventeenth lens element L17 are cemented to each other. The surface of sixteenth lens element L16 at the object side is aspheric.

Each lens group moves in zooming from a wide angle end to a telephoto end such that the space between first lens group G1 and second lens group G2 is increased, the space between second lens group G2 and third lens group G3 is decreased, the space between third lens group G3 and fourth lens group G4 is decreased, the space between fourth lens group G4 and fifth lens group G5 is increased, the space between fifth lens group G5 and sixth lens group G6 is decreased, and the space between sixth lens group G6 and seventh lens group G7 is increased.

In focusing from an infinity in-focus condition to a close-object in-focus condition, fourth lens group G4 and sixth lens group G6 move along an optical axis. In addition, eighth lens element L8 which is a part of third lens group G3 moves in the direction perpendicular to the optical axis as an image blur compensation lens group in order to compensate image blur upon vibration of the optical system.

### Fourth Exemplary Embodiment

First lens group G1 includes first lens element L1 having a positive meniscus shape with a convex surface facing an object side.

Second lens group G2 includes, in order from the object side to an image side, second lens element L2 having a negative meniscus shape with a convex surface facing the object side, biconcave third lens element L3, biconvex fourth lens element L4, and fifth lens element L5 having a negative meniscus shape with a convex surface facing the image side. The surface of second lens element L2 at the object side is aspheric.

Third lens group G3 includes, in order from the object side to the image side, biconvex sixth lens element L6, aperture diaphragm A, seventh lens element L7 having a positive meniscus shape with a convex surface facing the object side, eighth lens element L8 having a negative meniscus shape with a convex surface facing the object side, biconvex ninth lens element L9, and biconcave tenth lens element L10. Seventh lens element L7 and eighth lens element L8 are cemented to each other. The surface of seventh lens element L7 at the object side and the surfaces of tenth lens element L10 at the object side and the image side are aspheric.

Fourth lens group G4 includes, in order from the object side to the image side, biconvex eleventh lens element L11 and twelfth lens element L12 having a negative meniscus shape with a convex surface facing the object side. The surfaces of twelfth lens element L12 at the object side and the image side are aspheric.

Fifth lens group G5 includes, in order from the object side to the image side, thirteenth lens element L13 having a negative meniscus shape with a convex surface facing the object side and fourteenth lens element L14 having a negative meniscus shape with a convex surface facing the object side. Thirteenth lens element L13 and fourteenth lens element L14 are cemented to each other.

Sixth lens group G6 includes, in order from the object side to the image side, fifteenth lens element L15 having a negative meniscus shape with a convex surface facing the object side and sixteenth lens element L16 having a positive meniscus shape with a convex surface facing the object side.

Fifteenth lens element L15 and sixteenth lens element L16 are cemented to each other.

Each lens group moves in zooming from a wide angle end to a telephoto end such that the space between first lens group G1 and second lens group G2 is increased, the space between second lens group G2 and third lens group G3 is decreased, the space between third lens group G3 and fourth lens group G4 is decreased, the space between fourth lens group G4 and fifth lens group G5 is decreased, and the space between fifth lens group G5 and sixth lens group G6 is increased.

In focusing from an infinity in-focus condition to a close-object in-focus condition, fifth lens group G5 moves toward the image side along an optical axis. In addition, tenth lens element L10 which is a part of third lens group G3 moves in the direction perpendicular to the optical axis as an image blur compensation lens group in order to compensate image blur upon vibration of the optical system.

### Fifth Exemplary Embodiment

First lens group G1 includes, in order from an object side to an image side, first lens element L1 having a negative meniscus shape with a convex surface facing the object side and second lens element L2 having a positive meniscus shape with a convex surface facing the object side. First lens element L1 and second lens element L2 are cemented to each other.

Second lens group G2 includes, in order from the object side to the image side, third lens element L3 having a negative meniscus shape with a convex surface facing the object side, biconcave fourth lens element L4, biconvex fifth lens element L5, biconvex sixth lens element L6, and seventh lens element L7 having a negative meniscus shape with a convex surface facing the image side. The surfaces of fourth lens element L4 at the object side and the image side are aspheric.

Third lens group G3 includes, in order from the object side to the image side, aperture diaphragm A, biconvex eighth lens element L8, ninth lens element L9 having a negative meniscus shape with a convex surface facing the image side, biconvex tenth lens element L10, and biconcave eleventh lens element L11. Tenth lens element L10 and eleventh lens element L11 are cemented to each other. The surface of tenth lens element L10 at the object side is aspheric.

Fourth lens group G4 includes, in order from the object side to the image side, twelfth lens element L12 having a negative meniscus shape with a convex surface facing the object side, thirteenth lens element L13 having a positive meniscus shape with a convex surface facing the object side, biconvex fourteenth lens element L14, and biconvex fifteenth lens element L15. Twelfth lens element L12 and thirteenth lens element L13 are cemented to each other. The surfaces of fourteenth lens element L14 at the object side and the image side and the surfaces of fifteenth lens element L15 at the object side and the image side are aspheric.

Fifth lens group G5 includes sixteenth lens element L16 having a negative meniscus shape with a convex surface facing the object side.

Sixth lens group G6 includes, in order from the object side to the image side, biconcave seventeenth lens element L17 and biconvex eighteenth lens element L18. Seventeenth lens element L17 and eighteenth lens element L18 are cemented to each other.

Each lens group moves in zooming from a wide angle end to a telephoto end such that the space between first lens group G1 and second lens group G2 is increased, the space between second lens group G2 and third lens group G3 is decreased, the space between third lens group G3 and fourth lens group G4 is decreased, the space between fourth lens group G4 and fifth lens group G5 is decreased, and the space between fifth lens group G5 and sixth lens group G6 is decreased.

In focusing from an infinity in-focus condition to a close-object in-focus condition, fifth lens group G5 moves along an optical axis. In addition, fourteenth lens element L14 which is a part of fourth lens group G4 moves in the direction perpendicular to the optical axis as an image blur compensation lens group in order to compensate image blur upon vibration of the optical system.

### Sixth Exemplary Embodiment

First lens group G1 includes first lens element L1 having a positive meniscus shape with a convex surface facing an object side.

Second lens group G2 includes, in order from the object side to an image side, second lens element L2 having a negative meniscus shape with a convex surface facing the object side, biconcave third lens element L3, fourth lens element L4 having a positive meniscus shape with a convex surface facing the object side, biconvex fifth lens element L5, biconvex sixth lens element L6, and seventh lens element L7 having a negative meniscus shape with a convex surface facing the image side. Fourth lens element L4 and fifth lens element L5 are cemented to each other. The surfaces of third lens element L3 at the object side and the image side are aspheric.

Third lens group G3 includes aperture diaphragm A and biconvex eighth lens element L8 in order from the object side to the image side.

Fourth lens group G4 includes, in order from the object side to the image side, biconcave ninth lens element L9, biconvex tenth lens element L10, biconcave eleventh lens element L11, twelfth lens element L12 having a negative meniscus shape with a convex surface facing the object side, thirteenth lens element L13 having a positive meniscus shape with a convex surface facing the object side, biconvex fourteenth lens element L14, and biconvex fifteenth lens element L15. Tenth lens element L10 and eleventh lens element L11 are cemented to each other, and twelfth lens element L12 and thirteenth lens element L13 are cemented to each other. The surface of tenth lens element L10 at the object side, the surfaces of fourteenth lens element L14 at the object side and the image side, and the surfaces of fifteenth lens element L15 at the object side and the image side are aspheric.

Fifth lens group G5 includes sixteenth lens element L16 having a negative meniscus shape with a convex surface facing the object side.

Sixth lens group G6 includes, in order from the object side to the image side, biconcave seventeenth lens element L17 and biconvex eighteenth lens element L18. Seventeenth lens element L17 and eighteenth lens element L18 are cemented to each other.

Each lens group moves in zooming from a wide angle end to a telephoto end such that the space between first lens group G1 and second lens group G2 is increased, the space between second lens group G2 and third lens group G3 is decreased, the space between third lens group G3 and fourth lens group G4 is decreased, the space between fourth lens group G4 and fifth lens group G5 is decreased, and the space between fifth lens group G5 and sixth lens group G6 is decreased.

In focusing from an infinity in-focus condition to a close-object in-focus condition, fifth lens group G5 moves along an optical axis. In addition, fourteenth lens element L14 which is a part of fourth lens group G4 moves in the direction perpendicular to the optical axis as an image blur compensation lens group in order to compensate image blur upon vibration of the optical system.

In the first to sixth exemplary embodiments, each lens group moves toward the object side along an optical axis and aperture diaphragm A moves along the optical axis together with third lens group G3 in zooming from a wide angle end to a telephoto end such that the space between first lens group G1 and second lens group G2 becomes larger at the telephoto end than at the wide angle end and the space between second lens group G2 and third lens group G3 becomes smaller at the telephoto end than at the wide angle end.

It is preferable that first lens group G1 moves along the optical axis in zooming from a wide angle end to a telephoto end as in the zoom lens systems according to the first to sixth exemplary embodiments.

With the configuration in which first lens group G1 is movable, ray height of subsequent lens groups can be reduced. Thus, reduction in diameter of subsequent lens groups can be implemented. In addition, reduction in diameter and reduction in weight of a focusing lens group in an optical system using inner focus system can be implemented.

It is preferable that second lens group G2 moves along the optical axis in zooming from a wide angle end to a telephoto end. With the configuration in which second lens group G2 moves relative to an image plane in zooming from a wide angle end to a telephoto end, curvature of field can be corrected throughout the entire zooming region, and focusing performance can be enhanced.

It is also preferable that third lens group G3 moves along the optical axis in zooming from a wide angle end to a telephoto end. With the configuration which allows third lens group G3 to contribute to magnification change as a zoom lens group, focusing performance can be enhanced, while the zoom lens system is downsized.

It is also preferable that the subsequent lens group located closer to the image side than second lens group G2 moves along the optical axis in zooming from a wide angle end to a telephoto end. With the configuration in which the subsequent lens group is movable relative to the image plane, the zoom lens system can be downsized, and focusing performance can be enhanced while a zoom magnification is ensured.

It is also preferable that the most image-side lens group located closest to the image side moves along the optical axis in zooming from a wide angle end to a telephoto end. With the configuration in which the most image-side lens group is movable relative to the image plane, the zoom lens system can be downsized, and focusing performance can be enhanced while a zoom magnification is ensured.

In the zoom lens systems according to the first to sixth exemplary embodiments, a focusing lens group including two or less lens elements moves along the optical axis in focusing from an infinity in-focus condition to a close-object in-focus condition. With the configuration in which the focusing lens group includes two or less lens elements, the weight of the focusing lens group can be reduced.

It is also desirable that the focusing lens group includes a single lens element. In this case, high-speed focusing can be implemented with lightweight focusing lens group.

In the zoom lens system according to the third exemplary embodiment, two focusing lens groups move along the optical axis in focusing from an infinity in-focus condition to a close-object in-focus condition. With the configuration in which two or more lens groups move as a focusing lens group, optical performance at a close-object in-focus condition can satisfactorily be maintained.

In the zoom lens systems according to the first to sixth exemplary embodiments, the lens groups located closer to the image side than aperture diaphragm A or some lens element in the lens groups move in a direction perpendicular to the optical axis to compensate an image blur caused by vibration of an optical system. With the configuration in which image blur compensation is performed with image blur compensation lens group located closer to the image side than aperture diaphragm A, lens diameter of the image blur compensation lens group can be decreased. When the image blur compensation lens group is composed of a single lens, the configuration of an image blur compensation mechanism can be simplified, which contributes to downsizing of a lens barrel.

Further, with the configuration in which one or more subsequent groups having positive power are disposed closer to the image side than the image blur compensation lens group, optical performance in image blur compensation can satisfactorily be maintained.

In the zoom lens system according to each of the exemplary embodiments, first lens group G1 includes two or less lens elements including a lens element having positive power. With the configuration in which first lens group G1 includes two or less lens elements, the total length of the optical system can be decreased.

Still with the configuration in which first lens group G1 includes one lens element having positive power, the effect of decreasing the total length of the optical system can further be enhanced.

As in the zoom lens systems according to the first to sixth exemplary embodiments, second lens group G2 includes four or more lens elements. With the configuration in which second lens group includes four or more lens elements, spherical aberration at a telephoto end can satisfactorily be corrected. In order to ensure a large aperture at a telephoto end, it is necessary to open aperture diaphragm A wider at a telephoto end than at a wide angle end. However, this results in causing a lot of spherical aberration at the telephoto end, which adversely affects optical performance. However, with the configuration in which second lens group G2 includes four or more lens elements, spherical aberration occurring at the telephoto end can sufficiently be corrected.

Second lens group G2 includes two lens elements having negative power and one lens element having positive power in order from the object side to the image side. This configuration provides an effect of correcting curvature of field in an entire zoom region to enhance optical performance.

Third lens group G3 having aperture diaphragm A includes at least one or more biconvex lens element. This can effectively correct spherical aberration in the vicinity of aperture diaphragm A where on-axis luminous flux spreads.

The most image-side lens element closest to the image side in the zoom lens systems according to the first to sixth exemplary embodiments has positive power. With this, an incidence angle of ray incident on an imaging element disposed on an imaging surface can be lowered, whereby focusing performance can be enhanced. The most object-side lens element desirably has a convex surface at the object side. This can allow an incidence angle of ray incident on an imaging element to be shallower, thereby being capable of preventing an occurrence of distortion.

Conditions that a zoom lens system like the zoom lens systems according to the first to sixth exemplary embodiments preferably satisfies will be described below. Notably, a plurality of preferable conditions are specified for the zoom lens systems according to the first to sixth exemplary embodiments, and the configuration of a zoom lens system satisfying all of the plurality of conditions is the most desirable. However, it is possible to obtain a zoom lens system which satisfies an individual condition to provide the effect corresponding to the individual condition.

The zoom lens systems according to the first to sixth exemplary embodiments preferably satisfy condition (1) described below.

0.1<α2f/Wf<4.0 (1)

where

Wf: focal length at wide angle end

α2f: focal length of α2

Condition (1) specifies the focal length of the positive lens group having the second highest lens power out of the positive lens groups included in the subsequent lens group. When condition (1) is satisfied in the zoom lens systems according to the first to sixth exemplary embodiments, the total length of the optical system can be reduced, while optical performance can satisfactorily be maintained.

When the value exceeds the upper limit of condition (1), the lens power of the positive lens groups constituting the subsequent lens group becomes weak, resulting in that the total length of the optical system is increased. This is not preferable in implementing downsizing.

On the other hand, when the value becomes less than the lower limit of condition (1), the lens power of the positive lens groups constituting the subsequent lens group becomes too high in the entire optical system, so that various aberrations cannot be corrected. Thus, it becomes difficult to maintain high optical performance.

When the zoom lens systems according to the first to sixth exemplary embodiments satisfy at least either one of conditions (1)′ and (1)″ in addition to condition (1) described above, the above effect is more significantly exhibited.

0.5<α2f/Wf (1)′

α2f/Wf<3.5 (1)″

When the zoom lens systems according to the first to sixth exemplary embodiments satisfy at least either one of conditions (1)′″ and (1)″″ in addition to condition (1)′, (1)″, the above advantageous effect is more significantly exhibited.

1.0<α2f/Wf (1)′″

α2f/Wf<3.0 (1)″″

The zoom lens systems according to the first to sixth exemplary embodiments preferably satisfy condition (2) described below.

2.7<G1f/Wf<14.0 (2)

where

G1f: focal length of first lens group

Condition (2) specifies the focal length of the first lens group. When condition (2) is satisfied, the effective diameter of the second lens group can be reduced, when incident ray is converged by first lens group and incident on second lens group. Thus, the entire system can be downsized. When the value exceeds the upper limit of condition (2), the lens power of the first lens group becomes weak, the degree of convergence of ray incident on the second lens group becomes small, and the effective diameter of the second lens group is increased to make it difficult to downsize the entire system. On the other hand, when the value becomes less than the lower limit of condition (2), it becomes difficult to satisfactorily correct aberration occurring on the first lens group with two or less lens elements, resulting in that the number of lens elements constituting the first lens group might be increased. With this, the overall length of the optical system is increased, which is unsuitable for downsizing.

When the zoom lens systems according to the first to sixth exemplary embodiments satisfy at least either one of conditions (2)′ and (2)″ in addition to condition (2) described above, the above effect is further exhibited.

3.0<G1f/Wf (2)′

G1f/Wf<10.0 (2)″

When the zoom lens systems according to the first to sixth exemplary embodiments satisfy at least either one of conditions (2)′″ and (2)″″ in addition to condition (2)′ and (2)″ described above, the above effect is more significantly exhibited.

3.3<G1f/Wf (2)′″

G1f/Wf<7.0 (2)″″

The zoom lens systems according to the first to sixth exemplary embodiments preferably satisfy condition (3) described below.

0.1<G1D/Wf<1.0 (3)

where

G1D: Thickness of First Lens Group G1 on Optical Axis

Condition (3) specifies thickness of lens in the first lens group on the optical axis. When condition (3) is satisfied, optical performance can satisfactorily be corrected, while the first lens group is kept compact. When the value exceeds the upper limit of condition (3), an optical path of incident light passing through the first lens group becomes long, and chromatic aberration is deteriorated, when the first lens group includes two or less elements. Thus, this is not preferable. On the other hand, when the value becomes less than the lower limit of condition (3), it becomes difficult to constitute the first lens element with a lens element having appropriate lens power, and therefore, the effective diameter of the second lens group is increased to entail an increase in diameter of a lens barrel. Thus, this is not preferable.

When the zoom lens systems according to the first to sixth exemplary embodiments satisfy at least either one of conditions (3)′ and (3)″ in addition to condition (3) described above, the above effect is more significantly exhibited.

0.2<G1D/Wf (3)′

G1D/Wf<0.5 (3)″

The zoom lens systems according to the first to sixth exemplary embodiments preferably satisfy condition (4) described below.

0.5<|G2f/Wf|<1.5 (4)

where

G2f: Focal length of second lens group G2

Condition (4) specifies the focal length of the second lens group. When condition (4) is satisfied, optical performance can satisfactorily be corrected, while the first lens group is kept compact. When the value exceeds the upper limit of condition (4), the position of ray incident on the first lens group becomes high, so that a sufficient peripheral light amount ratio cannot be ensured. On the other hand, when the value becomes less than the lower limit of condition (4), the lens power of the second lens group becomes strong, so that aberration correction becomes difficult.

When the zoom lens systems according to the first to sixth exemplary embodiments satisfy at least either one of conditions (4)′ and (4)″ in addition to condition (4) described above, the above effect is more significantly exhibited.

0.8<|G2f/Wf| (4)′

|G2f/Wf|<1.2 (4)″

The zoom lens systems according to the first to sixth exemplary embodiments preferably satisfy condition (5) described below.

2.0<|G1f/G2f|<8.0 (5)

Condition (5) specifies the ratio between the focal length of the first lens group and the focal length of the second lens group. When condition (5) is satisfied, optical performance can satisfactorily be maintained, while the first lens group and the second lens group are kept to have small diameters. When the value exceeds the upper limit of condition (5), the position of ray incident on the first lens group becomes high, so that a sufficient peripheral light amount ratio cannot be ensured. On the other hand, when the value becomes less than the lower limit of condition (5), aberration correction becomes difficult with a compact optical system including two or less lens elements, resulting in that satisfactory optical performance cannot be maintained. Thus, this is not preferable.

When the zoom lens systems according to the first to sixth exemplary embodiments satisfy at least either one of conditions (5)′ and (5)″ in addition to condition (5) described above, the above effect is more significantly exhibited.

3.5<|G1f/G2f| (5)′

|G1f/G2f|<7.0 (5)″

The zoom lens systems according to the first to sixth exemplary embodiments preferably satisfy condition (6) described below.

0.02<G2LD/Wf<1.0 (6)

where

G2LD: Thickness of thinnest lens element in second lens group

Condition (6) specifies the thickness of the thinnest lens element out of lens elements constituting the second lens group.

When condition (6) is satisfied, optical performance can be satisfactorily maintained, while the thickness of the second lens group is decreased to keep the optical system compact. When the value exceeds the upper limit of condition (6), a lot of lateral chromatic aberration of off-axis ray occurs especially at a wide angle end, so that it becomes difficult to ensure satisfactory optical performance. On the other hand, when the value becomes less than the lower limit of condition (6), the occurrence of curvature of field at peripheral angle of view becomes significant.

When the zoom lens systems according to the first to sixth exemplary embodiments satisfy at least either one of conditions (6)′ and (6)″ in addition to condition (6) described above, the above effect is more significantly exhibited.

0.03<G2LD/Wf (6)′

G2LD/Wf<0.07 (6)″

Each lens group in the zoom lens systems according to the first to sixth exemplary embodiments may only include refractive lens element (specifically, a lens of a type deflecting light on an interface between mediums having different refractive indices) changing incident ray with refraction.

Alternatively, each lens group may include any one or a combination of two or more of a diffractive lens element, a hybrid diffractive-refractive lens element, or a gradient index lens element. A diffractive lens element deflects incident ray with diffraction action. A hybrid diffractive-refractive lens element deflects incident ray with a combination of diffraction action and refraction action. A gradient index lens element deflects incident ray with gradual variation of the refractive index in a medium.

### Seventh Exemplary Embodiment

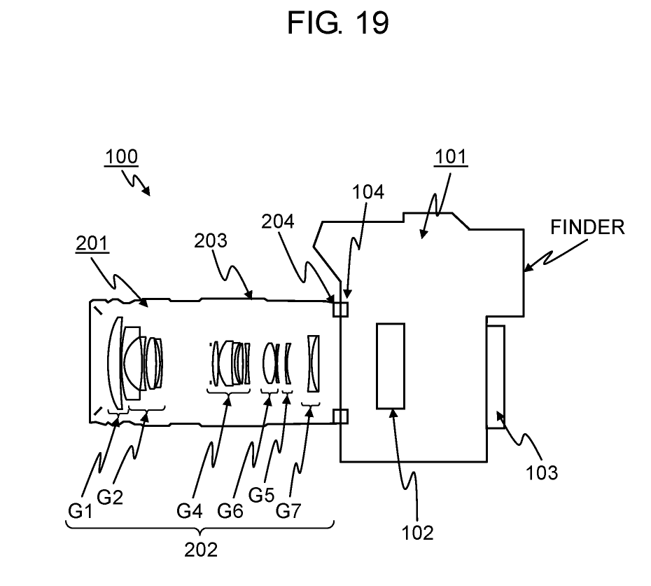

FIG. 19 is a schematic configuration diagram of an interchangeable lens digital camera system according to a seventh exemplary embodiment. Digital camera system 100 (hereinafter merely referred to as “camera system”) according to the present exemplary embodiment includes camera body 101 and interchangeable lens device 201 detachably connected to camera body 101.

Camera body 101 includes imaging element 102 that receives an optical image formed with zoom lens system 202 of interchangeable lens device 201 and converts the received image into an electric image signal, a liquid crystal monitor 103 that displays the image signal converted by imaging element 102, and camera mount section 104.

On the other hand, interchangeable lens device 201 includes zoom lens system 202 according to any one of the first to sixth exemplary embodiments, a lens barrel holding zoom lens system 202, and lens mount section 204 connected to camera mount section 104 of the camera body.

Camera mount section 104 and lens mount section 204 not only provide physical connection but also function as an interface that establishes electrical connection between a controller (not illustrated) mounted in camera body 101 and a controller (not illustrated) mounted in interchangeable lens device 201 to enable mutual signal communication.

In the seventh exemplary embodiment, zoom lens system 202 according to any one of the first to sixth exemplary embodiments is used. Accordingly, a compact interchangeable lens device having excellent focusing performance can be implemented with low cost. In addition, reduction in size and reduction in cost of entire camera system 100 according to the present exemplary embodiment can also be attained.

Numerical Examples for specifically configuring the zoom lens systems according to the first to sixth exemplary embodiments will be described below. As described below, Numerical Examples 1, 2, 3, 4, 5, and 6 correspond to the first to sixth exemplary embodiments, respectively.

In each Numerical Example, the units of length are all “mm”, while the units of field angle are all “°”.

Moreover, in each Numerical Example, r is a radius of curvature, d is an axial distance, nd is a refractive index to the d-line, and vd is Abbe number to the d-line.

In each Numerical Example, the surface marked with * is aspheric. The aspheric shape is defined by the following equation.

$$Z = \frac{{h}^{2} / r}{1 + \sqrt{1 - ( 1 + κ ) {( h / r )}^{2}}} + Σ {A}_{n} {h}^{n} \qquad [ Equation 1 ]$$

where

Z: distance from a point on the aspheric surface with height h from an optical axis to a tangent plane at the apex of the aspherical surface,

h: height from the optical axis,

r: curvature of radius at the apex,

k: conic constant, and

An: n-order aspheric surface coefficient

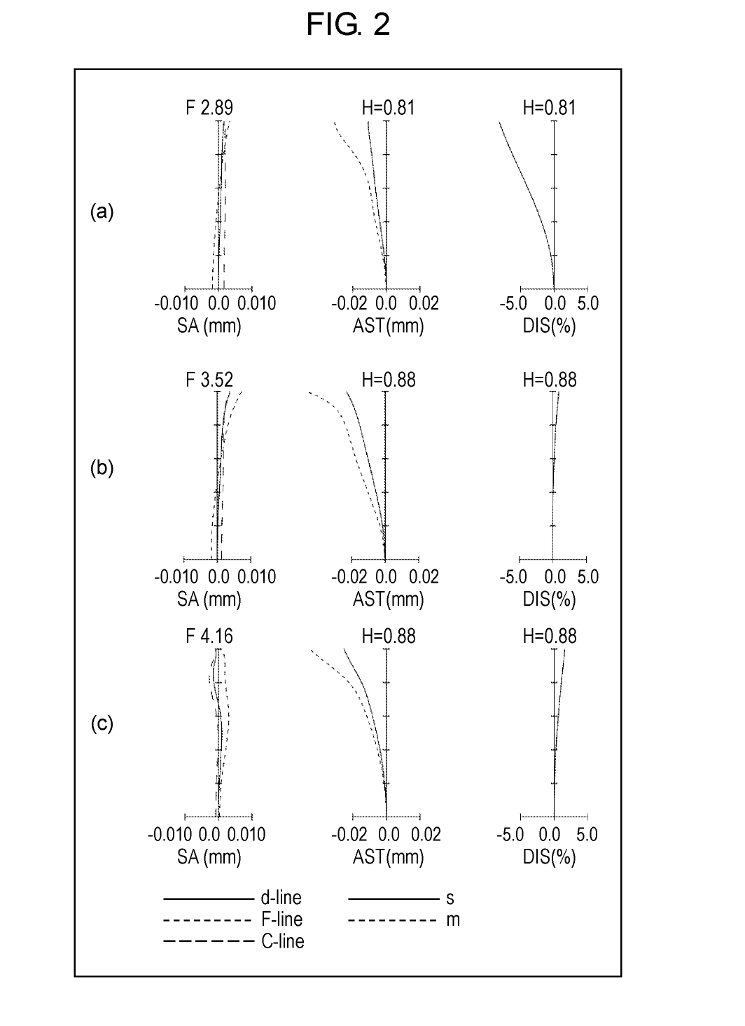

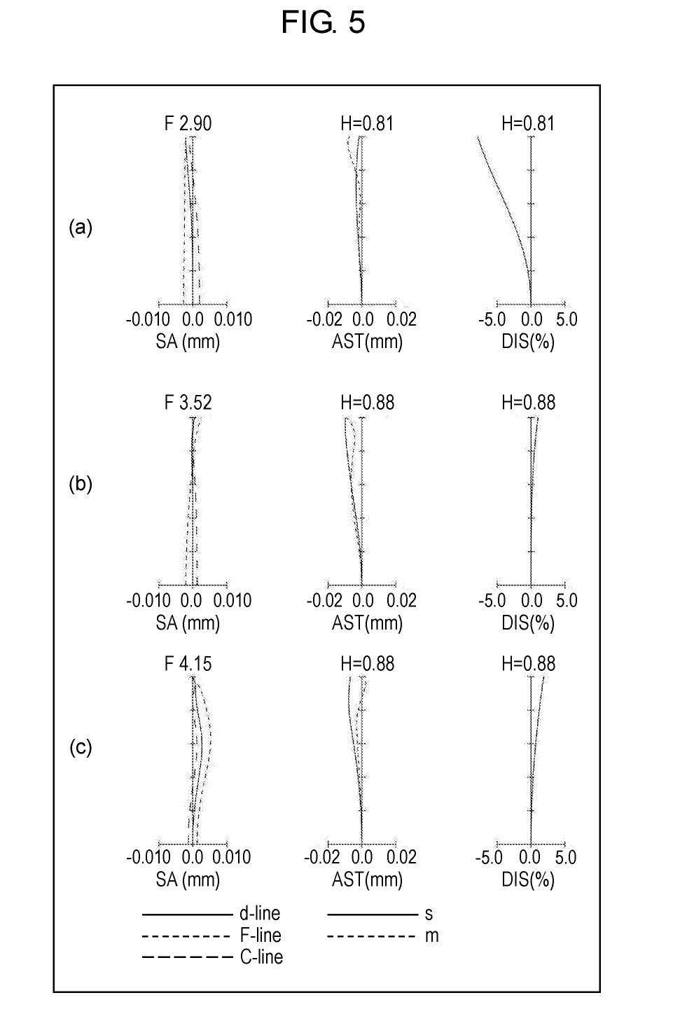

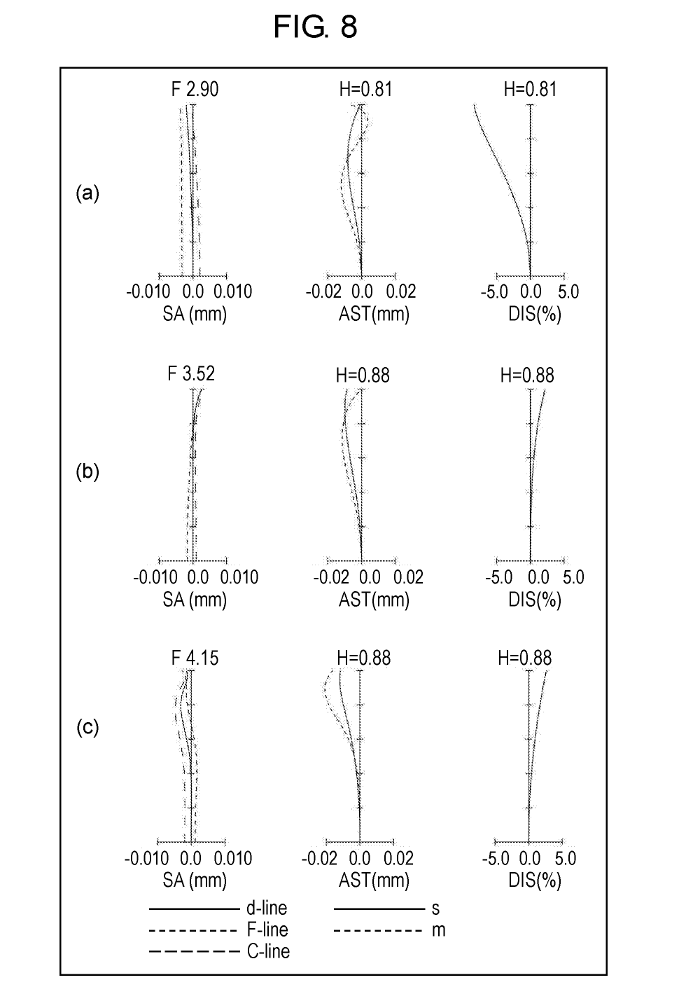

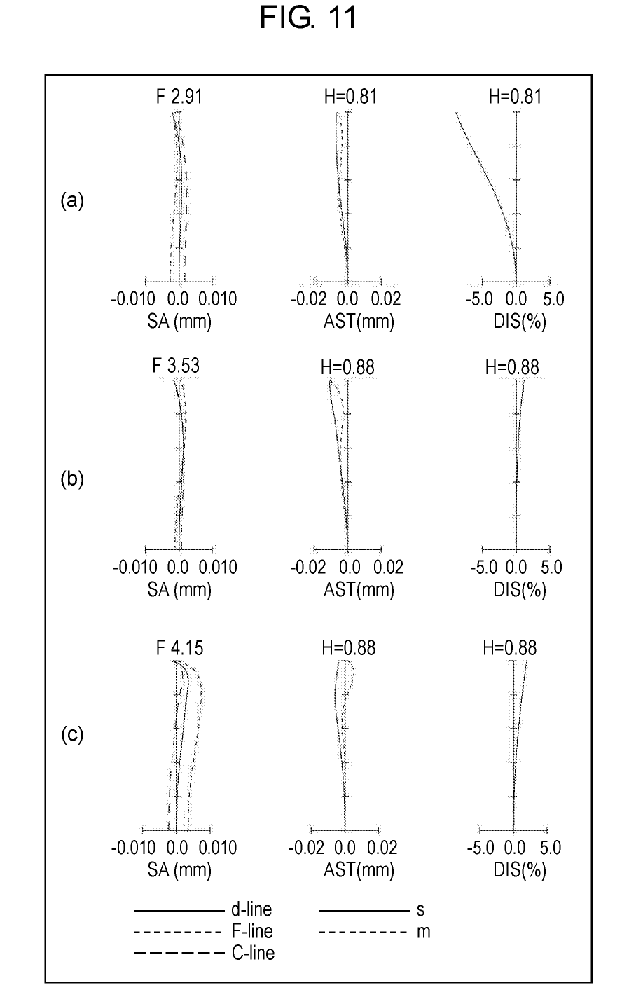

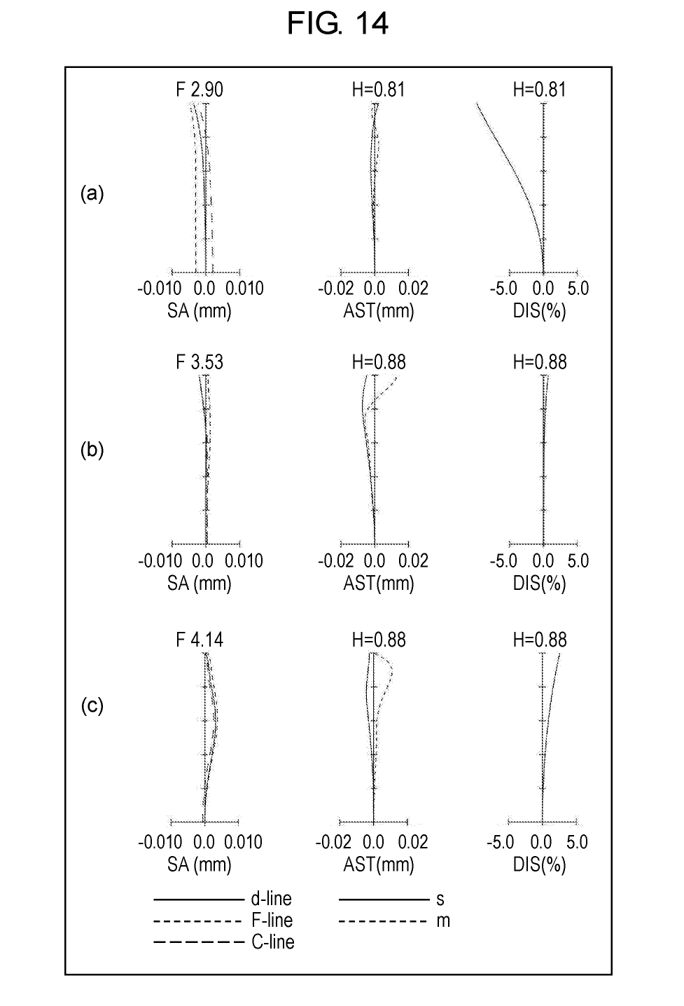

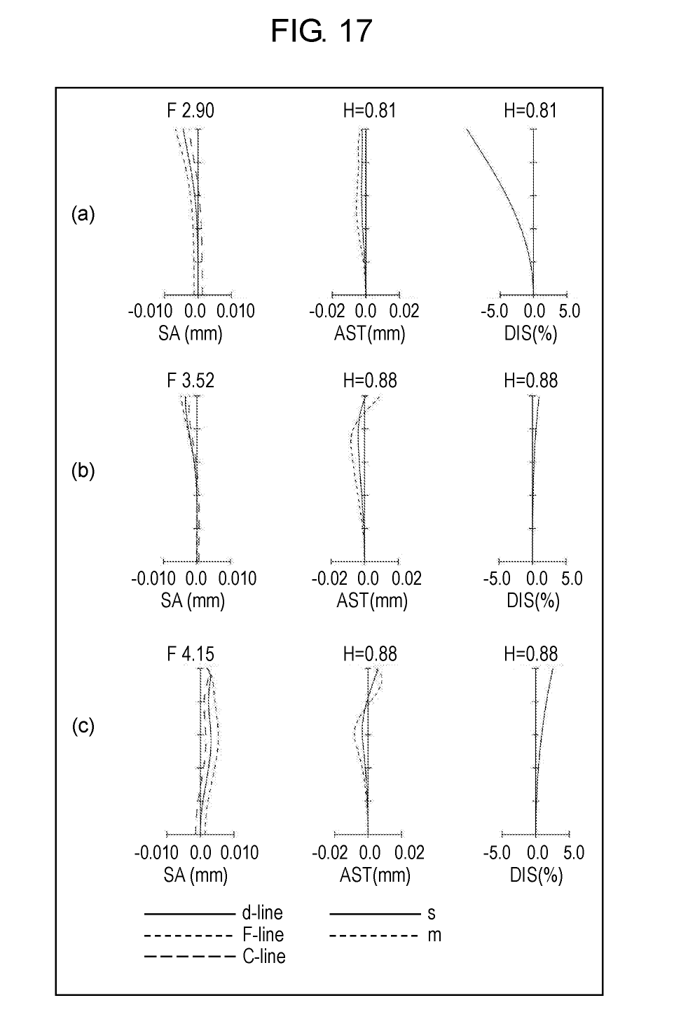

FIGS. 2, 5, 8, 11, 14, and 17 are axial aberration diagrams of an infinity in-focus condition of the zoom lens systems according to Numerical Examples 1, 2, 3, 4, 5, and 6, respectively.

In each axial aberration diagram, (a) shows the aberration at a wide angle end, (b) shows the aberration at a middle position, and (c) shows the aberration at a telephoto end. Each of the axial aberration diagrams (a) to (c) shows spherical aberration (SA (mm)), astigmatism (AST (mm)), and distortion (DIS (%)) in order from the left. In each spherical aberration diagram, a vertical axis indicates F-number (indicated as F in each figure), and the solid line, the short dash line and the long dash line indicate the characteristics to the d-line, the F-line and the C-line, respectively.

In each astigmatism diagram, the vertical axis indicates an image height (indicated as H in each figure), and the solid line and the dash line indicate characteristics to a sagittal plane (indicated as “s” in each figure) and a meridional plane (indicated as “m” in each figure), respectively. In each distortion diagram, the vertical axis indicates an image height (indicated as H in each figure).

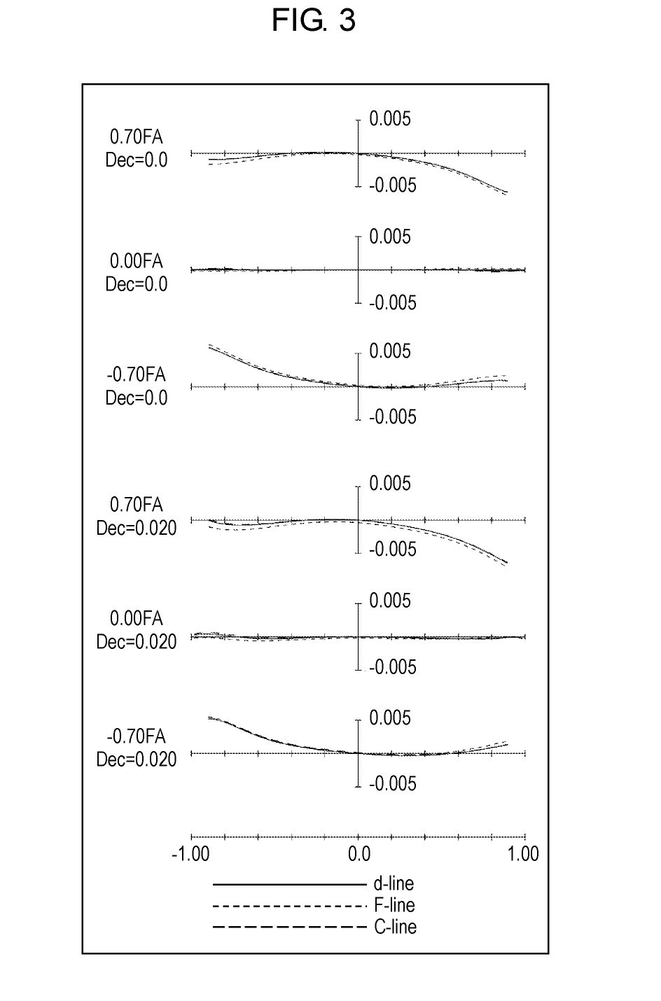

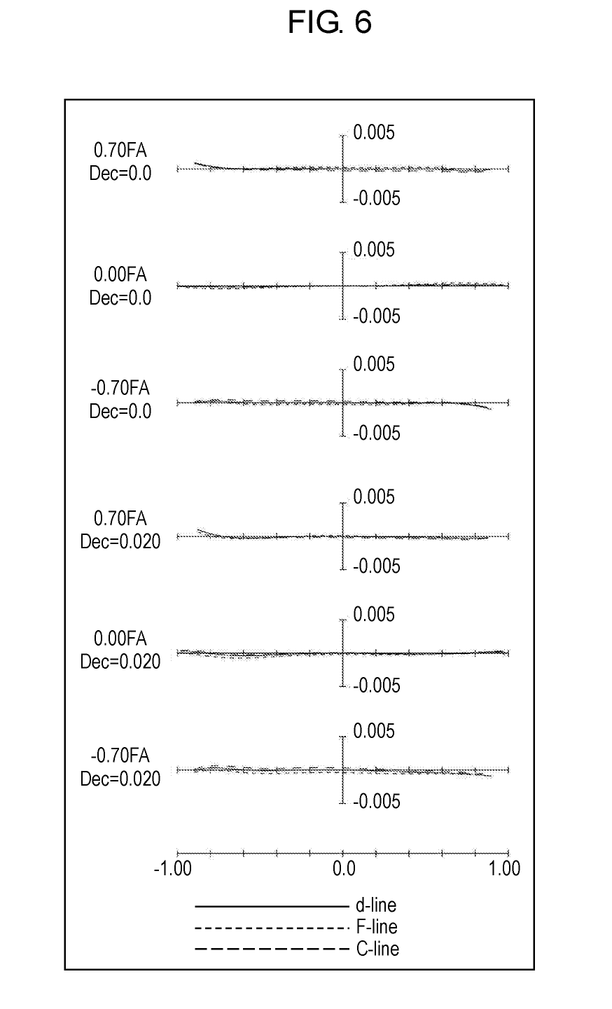

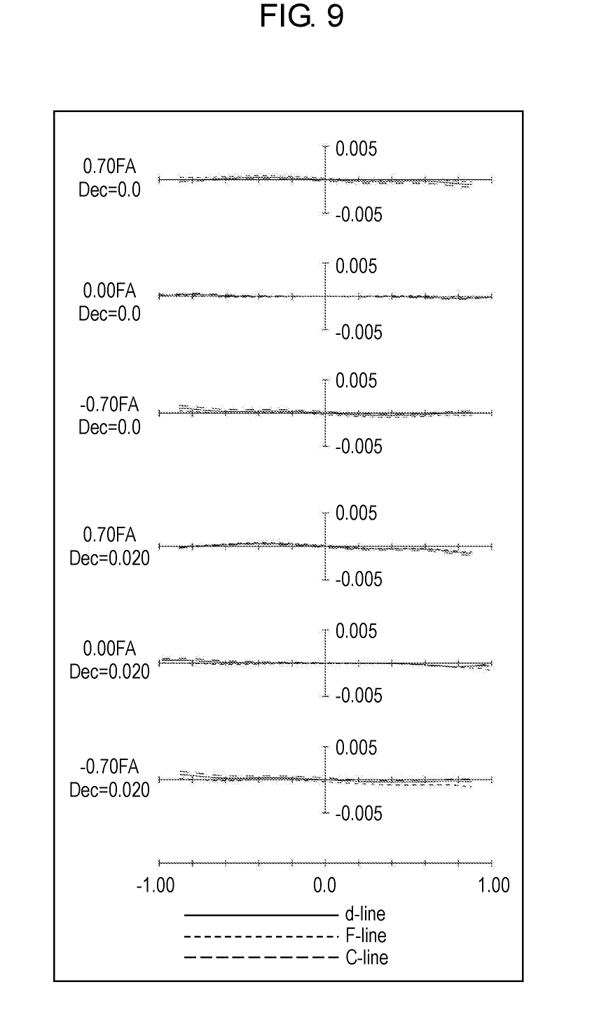

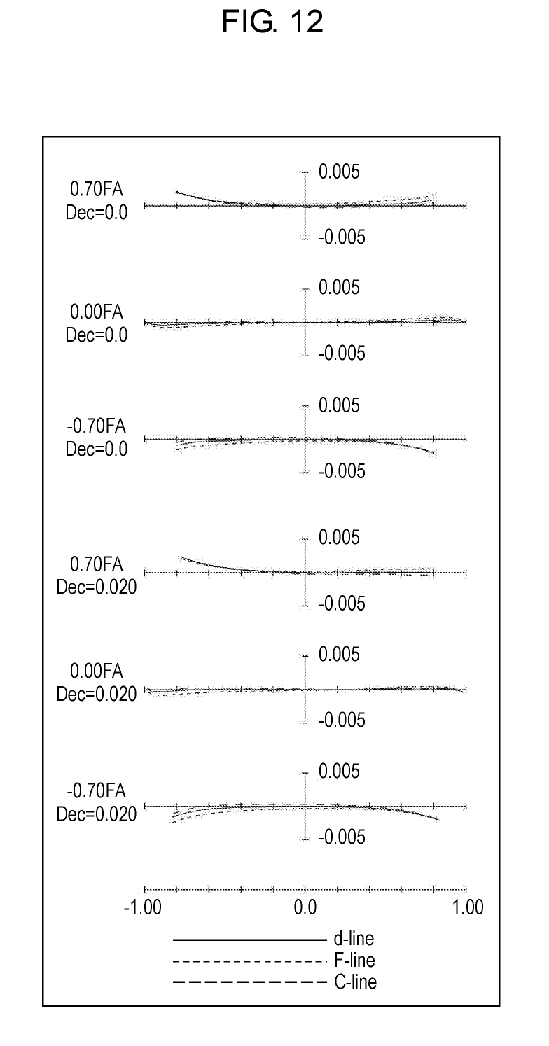

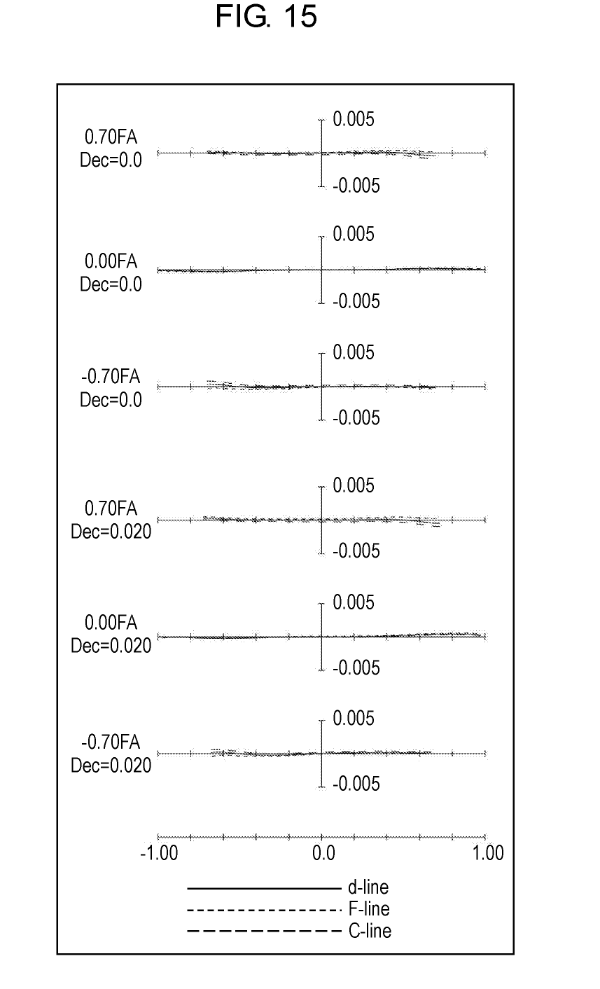

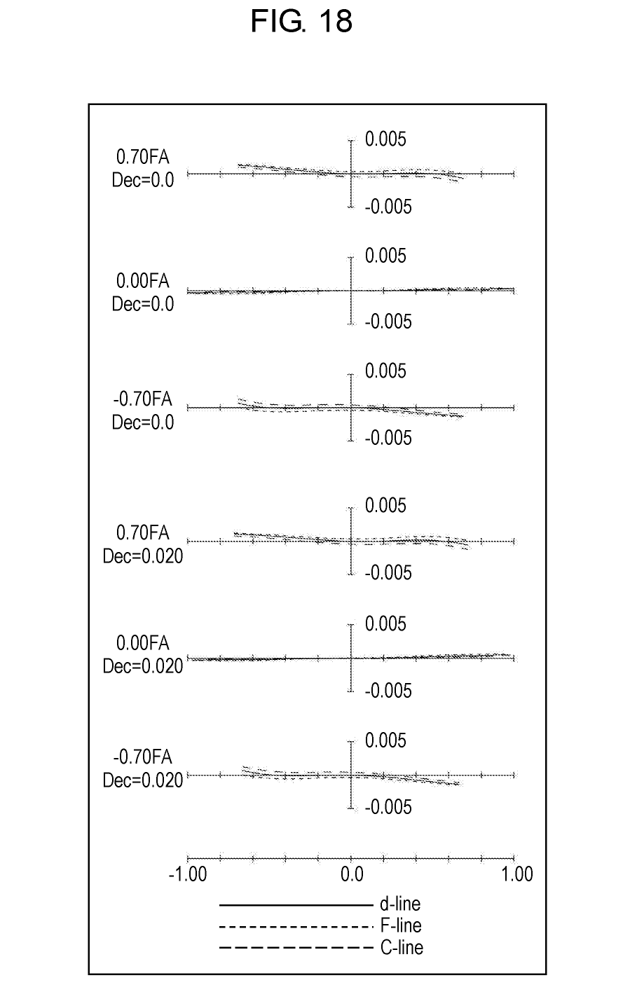

FIGS. 3, 6, 9, 12, 15, and 18 are lateral aberration diagrams of the zoom lens systems according to Numerical Examples 1, 2, 3, 4, 5, and 6 in a basic condition in which image blur compensation is not performed and in an image blur compensation condition.

In each lateral aberration diagram, the aberration diagrams in the upper three parts correspond to a basic condition where image blur compensation is not performed at a telephoto end, while the aberration diagrams in the lower three parts correspond to an image blur compensation condition where the image blur compensation lens group is moved by a predetermined amount in a direction perpendicular to the optical axis at a telephoto end.

Among the lateral aberration diagrams of a basic condition, the upper part shows the lateral aberration at an image point of 70% of the maximum image height, the middle part shows the lateral aberration at the axial image point, and the lower part shows the lateral aberration at an image point of −70% of the maximum image height.

Among the lateral aberration diagrams of an image blur compensation condition, the upper part shows the lateral aberration at an image point of 70% of the maximum image height, the middle part shows the lateral aberration at the axial image point, and the lower part shows the lateral aberration at an image point of −70% of the maximum image height.

In each lateral aberration diagram, the horizontal axis indicates the distance from the principal ray on the pupil surface, and the solid line, the short dash line and the long dash line indicate the characteristics to the d-line, the F-line and the C-line, respectively. In each lateral aberration diagram, the meridional plane is adopted as the plane containing the optical axis of first lens group G1.

In the zoom lens system according to each Numerical Example, the amount of movement (Y_{T} (mm)) of the image blur compensation sub-lens group in a direction perpendicular to the optical axis in an image blur compensation condition at a telephoto end is as shown in Table 1 below.

An image blur compensation angle is 0.3°. Specifically, the amount of movement of the image blur compensation sub-lens group shown in Table 1 below is equal to the amount of image decentering in a case that the optical axis of the zoom lens system tilts by 0.3°.

### (Amount of Movement of Image Blur Compensation Sub-Lens Group)

TABLE 1

| Numerical | Amount of movement |
|---|---|
| Example | Y_{T} (mm) |
| 1 | 0.020 |
| 2 | 0.020 |
| 3 | 0.020 |
| 4 | 0.020 |
| 5 | 0.020 |
| 6 | 0.020 |

### Numerical Example 1

The zoom lens system according to Numerical Example 1 corresponds to the first exemplary embodiment (FIG. 1). Table 2 shows the surface data of the zoom lens system, Table 3 shows the aspherical data, Table 4 shows various data of the lens system, Table 5 shows the single lens data, Table 6 shows the data of the zoom lens group, and Table 7 shows the magnification of the zoom lens group.

### (Surface Data)

TABLE 2
Surface data

| Surface number | r | d | nd | vd |
|---|---|---|---|---|
| Object surface | ∞ | | | |
| 1 | 2.64450 | 0.28440 | 1.58913 | 61.3 |
| 2 | 18.35480 | Variable | | |
| 3 | 3.47640 | 0.06500 | 1.79950 | 42.3 |
| 4 | 0.73130 | 0.38110 | | |
| 5* | −4.44990 | 0.04880 | 1.77377 | 47.2 |
| 6* | 2.87990 | 0.04790 | | |
| 7 | 2.03710 | 0.22350 | 1.84666 | 23.8 |
| 8 | −3.94590 | 0.09230 | | |
| 9 | −1.28770 | 0.04470 | 1.72916 | 54.7 |
| 10 | −3.53230 | Variable | | |
| 11 | ∞ | 0.04060 | | |
| (Diaphragm) | | | | |
| 12 | 2.00720 | 0.11040 | 1.84666 | 23.8 |
| 13 | −14.98750 | 0.02830 | | |
| 14* | 0.88400 | 0.28510 | 1.49710 | 81.6 |
| 15 | 4.63940 | 0.00040 | 1.56732 | 42.8 |
| 16 | 4.63940 | 0.04880 | 1.92286 | 20.9 |
| 17 | 0.93560 | 0.07260 | | |
| 18 | 1.42780 | 0.11510 | 1.49700 | 81.6 |
| 19 | −20.79580 | 0.07180 | | |
| 20* | −5.74970 | 0.04880 | 1.73077 | 40.5 |
| 21* | 5.42950 | Variable | | |
| 22 | 0.94390 | 0.26300 | 1.49700 | 81.6 |
| 23 | −1.51990 | 0.01630 | | |
| 24* | 4.14040 | 0.02570 | 1.59201 | 67.0 |
| 25* | 2.78790 | Variable | | |
| 26 | 4.42210 | 0.02840 | 1.71736 | 29.5 |
| 27 | 1.27380 | Variable | | |
| 28 | −6.41150 | 0.04470 | 1.64769 | 33.8 |
| 29 | 1.72550 | 0.00040 | 1.56732 | 42.8 |
| 30 | 1.72550 | 0.15470 | 1.94595 | 18.0 |
| 31 | 41.21710 | Variable | | |
| Image plane | ∞ | | | |

### (Aspherical Data)

TABLE 3
Aspherical data

| | | | | | |
|---|---|---|---|---|---|
| Surface No. 5 | K = 0.00000E+00 | A4 = −1.53857E−02 | A6 = −5.24209E−02 | A8 = −2.25170E−03 | A10 = −2.60768E−01 |
| Surface No. 6 | K = 0.00000E+00 | A4 = −1.14080E−01 | A6 = −9.14937E−02 | A8 = −1.36807E−01 | A10 = −2.72034E−01 |
| Surface No. 14 | K = 0.00000E+00 | A4 = −5.95098E−02 | A6 = −6.58922E−02 | A8 = −1.69241E−01 | A10 = −3.04775E−01 |
| Surface No. 20 | K = 0.00000E+00 | A4 = 2.02616E−02 | A6 = 1.18405E−01 | A8 = 2.69483E−01 | A10 = 2.31840E−01 |
| Surface No. 21 | K = 0.00000E+00 | A4 = 1.82391E−02 | A6 = 4.25821E−02 | A8 = 2.27078E−01 | A10 = 6.83112E−01 |
| Surface No. 24 | K = 0.00000E+00 | A4 = −3.08909E−01 | A6 = −1.12959E−01 | A8 = −3.67595E−02 | A10 = 1.04351E−01 |
| Surface No. 25 | K = 0.00000E+00 | A4 = 1.29829E−01 | A6 = 4.00455E−01 | A8 = −1.42983E−01 | A10 = −1.32594E+00 |

### (Various Data of Lens System)

TABLE 4
Various data of lens system
Zooming ratio 3.55606

| | Wide angle | Middle | Telephoto |
|---|---|---|---|
| Focal length | 1.0000 | 1.8855 | 3.5561 |
| F-number | 2.88863 | 3.51705 | 4.15676 |
| Field angle | 41.5172 | 24.8035 | 13.6723 |
| Image height | 0.8125 | 0.8790 | 0.8790 |
| Overall length of lens system | 5.3847 | 5.8381 | 6.9907 |
| d2 | 0.0203 | 0.5653 | 1.2093 |
| d10 | 1.0803 | 0.4337 | 0.0609 |
| d21 | 0.3356 | 0.1835 | 0.1097 |
| d25 | 0.1866 | 0.1706 | 0.1601 |
| d27 | 0.5069 | 0.6476 | 1.0337 |
| d31 | 0.7120 | 1.2943 | 1.8742 |
| Entrance pupil position | 1.1230 | 1.8419 | 2.9949 |
| Exit pupil position | −2.9173 | −3.3433 | −4.2536 |
| Front principal point position | 1.7802 | 2.6641 | 3.5780 |
| Back principal point position | 4.3847 | 3.9527 | 3.4347 |

### (Single Lens Data)

TABLE 5
Single lens data

| Lens | Initial surface | Focal length |
|---|---|---|
| 1 | 1 | 5.2095 |
| 2 | 3 | −1.1707 |
| 3 | 5 | −2.2530 |
| 4 | 7 | 1.6145 |
| 5 | 9 | −2.8027 |
| 6 | 12 | 2.0970 |
| 7 | 14 | 2.1429 |
| 8 | 16 | −1.2780 |
| 9 | 18 | 2.6929 |
| 10 | 20 | −3.8143 |
| 11 | 22 | 1.2147 |
| 12 | 24 | −14.5188 |
| 13 | 26 | −2.5035 |
| 14 | 28 | −2.0946 |
| 15 | 30 | 1.9002 |

### (Data of Zoom Lens Group)

TABLE 6
Data of zoom lens group

| | | | | Front | Back |
|---|---|---|---|---|---|
| | | | Overall | principal | principal |
| | Initial | | length | point | point |
| Lens group | surface | Focal length | of lens | position | position |
| 1 | 1 | 5.20947 | 0.28440 | −0.02992 | 0.07670 |
| 2 | 3 | −0.91966 | 0.90330 | 0.12711 | 0.34640 |
| 3 | 11 | 2.16526 | 0.82190 | −0.41997 | −0.02910 |
| 4 | 22 | 1.30801 | 0.30500 | 0.05370 | 0.14637 |
| 5 | 26 | −2.50355 | 0.02840 | 0.02332 | 0.03512 |
| 6 | 28 | 20.23015 | 0.19980 | 0.04655 | 0.13971 |

### (Magnification of Zoom Lens Group)

TABLE 7
Magnification of zoom lens group

| Lens group | Initial surface | Wide angle | Middle | Telephoto |
|---|---|---|---|---|
| 1 | 1 | 0.00000 | 0.00000 | 0.00000 |
| 2 | 3 | −0.23373 | −0.27131 | −0.33495 |
| 3 | 11 | −11.60381 | 5.08944 | 2.92714 |
| 4 | 22 | 0.04781 | −0.15148 | −0.33719 |
| 5 | 26 | 1.53910 | 1.85454 | 2.28312 |
| 6 | 28 | 0.96182 | 0.93303 | 0.90438 |

### Numerical Example 2

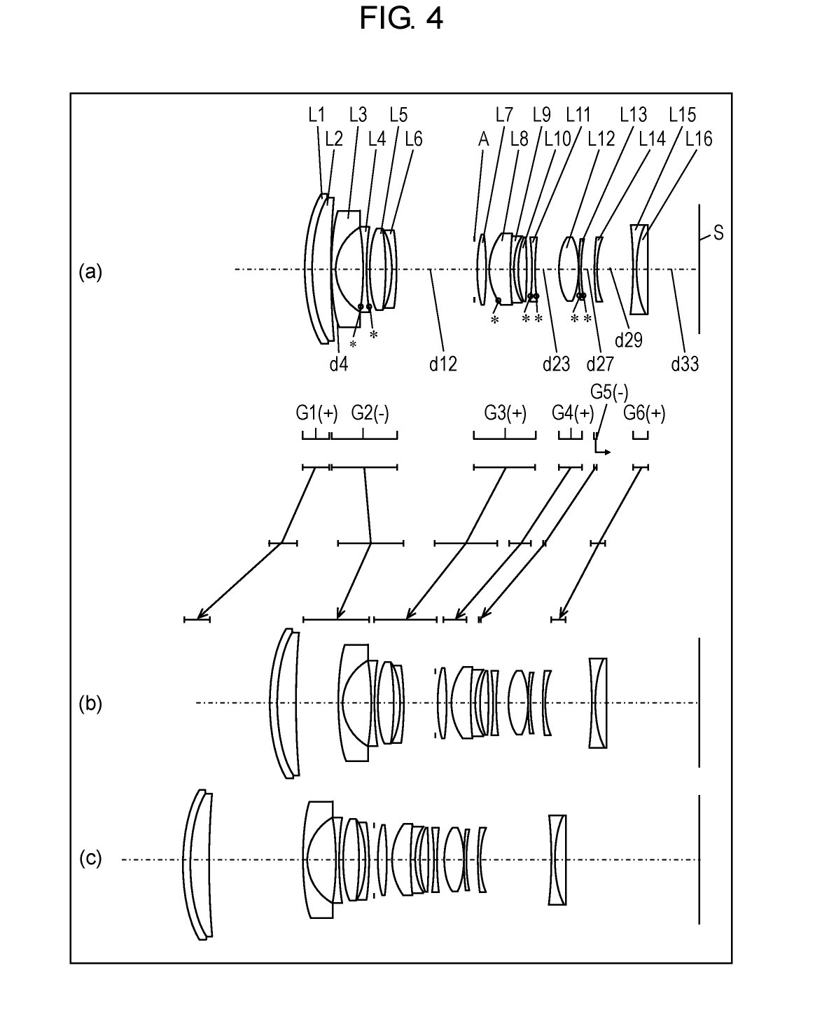

The zoom lens system according to Numerical Example 2 corresponds to the second exemplary embodiment (FIG. 4).

Table 8 shows the surface data of the zoom lens system, Table 9 shows the aspherical data, Table 10 shows various data of the lens system, Table 11 shows the single lens data, Table 12 shows the data of the zoom lens group, and Table 13 shows the magnification of the zoom lens group.

### (Surface Data)

TABLE 8
Surface data

| Surface number | r | d | nd | νd |
|---|---|---|---|---|
| Object surface | ∞ | | | |
| 1 | 2.86700 | 0.08090 | 1.48749 | 70.4 |
| 2 | 2.47620 | 0.00040 | 1.56732 | 42.8 |
| 3 | 2.47620 | 0.28320 | 1.59349 | 67.0 |
| 4 | 18.00380 | Variable | | |
| 5 | 3.51020 | 0.06470 | 1.79950 | 42.3 |
| 6 | 0.73410 | 0.38270 | | |
| 7* | −4.55070 | 0.04850 | 1.77377 | 47.2 |
| 8* | 2.78830 | 0.05020 | | |
| 9 | 2.02930 | 0.22250 | 1.84666 | 23.8 |
| 10 | −3.82480 | 0.10560 | | |
| 11 | −1.26880 | 0.04450 | 1.72916 | 54.7 |
| 12 | −3.40860 | Variable | | |
| 13 (Diaphragm) | ∞ | 0.04050 | | |
| 14 | 2.05600 | 0.13830 | 1.84666 | 23.8 |
| 15 | −12.32230 | 0.06850 | | |
| 16* | 0.88390 | 0.28250 | 1.49710 | 81.6 |
| 17 | 4.69520 | 0.00040 | 1.56732 | 42.8 |
| 18 | 4.69520 | 0.04850 | 1.92286 | 20.9 |
| 19 | 0.93770 | 0.07260 | | |
| 20 | 1.48340 | 0.11370 | 1.49700 | 81.6 |
| 21 | −12.38320 | 0.06810 | | |
| 22* | −5.96990 | 0.04850 | 1.73077 | 40.5 |
| 23* | 5.16280 | Variable | | |
| 24 | 0.94390 | 0.28320 | 1.49700 | 81.6 |
| 25 | −1.49850 | 0.01620 | | |
| 26* | 4.09540 | 0.02230 | 1.59201 | 67.0 |
| 27* | 2.74320 | Variable | | |
| 28 | 4.74620 | 0.02830 | 1.71736 | 29.5 |
| 29 | 1.28420 | Variable | | |
| 30 | −7.45690 | 0.04450 | 1.64769 | 33.8 |
| 31 | 1.66650 | 0.00040 | 1.56732 | 42.8 |
| 32 | 1.66650 | 0.15530 | 1.94595 | 18.0 |
| 33 | 23.13950 | Variable | | |
| Image plane | ∞ | | | |

### (Aspherical Data)

TABLE 9
Aspherical data

| | | | | | |
|---|---|---|---|---|---|
| Surface No. 7 | K = 0.00000E+00 | A4 = −1.55544E−02 | A6 = −5.44432E−02 | A8 = 7.29638E−03 | A10 = −2.57623E−01 |
| Surface No. 8 | K = 0.00000E+00 | A4 = −1.15277E−01 | A6 = −9.40161E−02 | A8 = −1.31434E−01 | A10 = −2.79242E−01 |
| Surface No. 16 | K = 0.00000E+00 | A4 = −5.86529E−02 | A6 = −7.45649E−02 | A8 = −1.61100E−01 | A10 = −3.25123E−01 |
| Surface No. 22 | K = 0.00000E+00 | A4 = 1.72491E−02 | A6 = 1.19046E−01 | A8 = 1.70057E−01 | A10 = −9.40321E−02 |
| Surface No. 23 | K = 0.00000E+00 | A4 = 1.57919E−02 | A6 = 4.99380E−02 | A8 = 1.19562E−01 | A10 = 3.02615E−01 |
| Surface No. 26 | K = 0.00000E+00 | A4 = −3.09483E−01 | A6 = −1.13761E−01 | A8 = −1.22679E−02 | A10 = −9.76663E−02 |
| Surface No. 27 | K = 0.00000E+00 | A4 = 1.29759E−01 | A6 = 4.04151E−01 | A8 = −1.53543E−01 | A10 = 1.75689E+00 |

### (Various Data of Lens System)

TABLE 10
Various data of lens system
Zooming ratio 3.53161

| | Wide angle | Middle | Telephoto |
|---|---|---|---|
| Focal length | 1.0000 | 1.8795 | 3.5317 |
| F-number | 2.90181 | 3.52419 | 4.14532 |
| Field angle | 41.2927 | 24.7412 | 13.6673 |
| Image height | 0.8090 | 0.8750 | 0.8750 |
| Overall length of lens system | 5.5374 | 5.9813 | 7.1907 |
| d4 | 0.0202 | 0.5763 | 1.3085 |
| d12 | 1.0813 | 0.4231 | 0.0606 |
| d23 | 0.3274 | 0.1645 | 0.0932 |
| d27 | 0.1742 | 0.1694 | 0.1600 |
| d29 | 0.5022 | 0.6413 | 0.9959 |
| d33 | 0.7168 | 1.2913 | 1.8570 |
| Entrance pupil position | 1.1928 | 1.9237 | 3.2840 |
| Exit pupil position | −2.9758 | −3.3653 | −4.2291 |
| Front principal point position | 1.8568 | 2.7536 | 3.8667 |
| Back principal point position | 4.5374 | 4.1018 | 3.6590 |

### (Single Lens Data)

TABLE 11
Single lens data

| Lens | Initial surface | Focal length |
|---|---|---|
| 1 | 1 | −39.9765 |
| 2 | 3 | 4.8050 |
| 3 | 5 | −1.1732 |
| 4 | 7 | −2.2280 |
| 5 | 9 | 1.5937 |
| 6 | 11 | −2.7964 |
| 7 | 14 | 2.0903 |
| 8 | 16 | 2.1379 |
| 9 | 18 | −1.2776 |
| 10 | 20 | 2.6727 |
| 11 | 22 | −3.7816 |
| 12 | 24 | 1.2119 |
| 13 | 26 | −14.1206 |
| 14 | 28 | −2.4626 |
| 15 | 30 | −2.0990 |
| 16 | 32 | 1.8918 |

### (Data of Zoom Lens Group)

TABLE 12
Data of zoom lens group

| | | | Overall | Front | Back |
|---|---|---|---|---|---|
| Lens | Initial | Focal | length | principal | principal |
| group | surface | length | of lens | point position | point position |
| 1 | 1 | 5.52384 | 0.36450 | −0.02936 | 0.10457 |
| 2 | 5 | −0.92400 | 0.91870 | 0.12832 | 0.35011 |
| 3 | 13 | 2.14936 | 0.88160 | −0.41700 | 0.00000 |
| 4 | 24 | 1.30746 | 0.32170 | 0.05941 | 0.15653 |
| 5 | 28 | −2.46263 | 0.02830 | 0.02267 | 0.03443 |
| 6 | 30 | 19.28072 | 0.20020 | 0.01023 | 0.10370 |

### (Magnification of Zoom Lens Group)

TABLE 13
Magnification of zoom lens group

| Lens group | Initial surface | Wide angle | Middle | Telephoto |
|---|---|---|---|---|
| 1 | 1 | 0.00000 | 0.00000 | 0.00000 |
| 2 | 5 | −0.22045 | −0.25418 | −0.31828 |
| 3 | 13 | −10.17526 | 5.16914 | 2.98908 |
| 4 | 24 | 0.05434 | −0.14927 | −0.32670 |
| 5 | 28 | 1.55052 | 1.86953 | 2.28900 |
| 6 | 30 | 0.95780 | 0.92800 | 0.89866 |

### Numerical Example 3

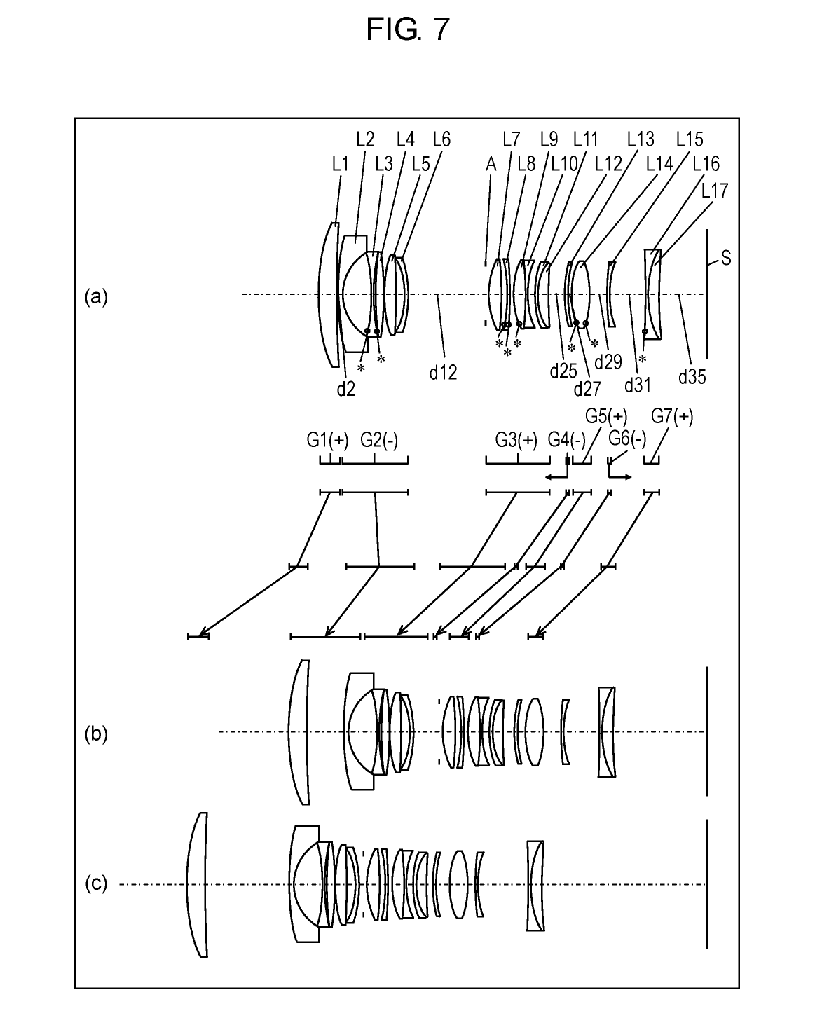

The zoom lens system according to Numerical Example 3 corresponds to the third exemplary embodiment (FIG. 7).

Table 14 shows the surface data of the zoom lens system, Table 15 shows the aspherical data, Table 16 shows various data of the lens system, Table 17 shows the single lens data, Table 18 shows the data of the zoom lens group, and Table 19 shows the magnification of the zoom lens group.

### (Surface Data)

TABLE 14
Surface data

| Surface number | r | d | nd | νd |
|---|---|---|---|---|
| Object surface | ∞ | | | |
| 1 | 2.77070 | 0.26290 | 1.58913 | 61.3 |
| 2 | 63.44800 | Variable | | |
| 3 | 5.25130 | 0.06470 | 1.80501 | 39.6 |
| 4 | 0.76170 | 0.39010 | | |
| 5* | −3.37210 | 0.04850 | 1.69320 | 33.7 |
| 6* | 2.73180 | 0.02760 | | |
| 7 | 9.18710 | 0.10640 | 1.84666 | 23.8 |
| 8 | −4.87600 | 0.01510 | | |
| 9 | 2.81260 | 0.15860 | 1.84666 | 23.8 |
| 10 | −8.18760 | 0.12120 | | |
| 11 | −1.11420 | 0.04450 | 1.72600 | 53.4 |
| 12 | −2.17050 | Variable | | |
| 13 (Diaphragm) | ∞ | 0.06070 | | |
| 14 | 1.46710 | 0.16180 | 1.84666 | 23.8 |
| 15 | −5.86500 | 0.08560 | | |
| 16* | −3.29520 | 0.02830 | 1.61881 | 63.9 |
| 17* | 18.38830 | 0.06100 | | |
| 18* | 1.06850 | 0.16240 | 1.49710 | 81.6 |
| 19 | −6.77320 | 0.00040 | 1.56732 | 42.8 |
| 20 | −6.77320 | 0.04850 | 1.92286 | 20.9 |
| 21 | 1.47070 | 0.09450 | | |
| 22 | 1.82230 | 0.04040 | 1.75520 | 27.5 |
| 23 | 0.83010 | 0.00040 | 1.56732 | 42.8 |
| 24 | 0.83010 | 0.15260 | 1.49700 | 81.6 |
| 25 | 5.65630 | Variable | | |
| 26 | 1.60330 | 0.04040 | 1.49700 | 81.4 |
| 27 | 1.30570 | Variable | | |
| 28* | 1.04150 | 0.26290 | 1.55332 | 71.7 |
| 29* | −1.36870 | Variable | | |
| 30 | 2.88200 | 0.04040 | 1.90366 | 31.3 |
| 31 | 1.04140 | Variable | | |
| 32* | −51.82780 | 0.04450 | 1.71700 | 47.9 |
| 33 | 1.49680 | 0.00040 | 1.56732 | 42.8 |
| 34 | 1.49680 | 0.14880 | 1.94595 | 18.0 |
| 35 | 7.05960 | Variable | | |
| Image plane | ∞ | | | |

### (Aspherical Data)

TABLE 15
Aspherical data

| | | | | | |
|---|---|---|---|---|---|
| Surface No. 5 | K = 0.00000E+00 | A4 = −5.54449E−03 | A6 = −8.95120E−02 | A8 = 2.81839E−01 | A10 = −7.25660E−01 |
| Surface No. 6 | K = 0.00000E+00 | A4 = −1.79061E−01 | A6 = −1.57152E−01 | A8 = 3.71764E−01 | A10 = −1.24682E+00 |
| Surface No. 16 | K = 0.00000E+00 | A4 = −3.70432E−03 | A6 = 7.93474E−04 | A8 = −1.54306E−02 | A10 = −2.52057E−01 |
| Surface No. 17 | K = 0.00000E+00 | A4 = −3.78210E−02 | A6 = 1.70701E−02 | A8 = −1.37734E−01 | A10 = −1.30982E−01 |
| Surface No. 18 | K = 0.00000E+00 | A4 = −9.52839E−02 | A6 = −1.11115E−01 | A8 = −2.19169E−01 | A10 = 8.35498E−02 |
| Surface No. 28 | K = 0.00000E+00 | A4 = −2.56277E−01 | A6 = −1.87708E−02 | A8 = 3.97761E−01 | A10 = −1.59801E+00 |
| Surface No. 29 | K = 0.00000E+00 | A4 = 1.48448E−01 | A6 = −1.41941E−01 | A8 = 4.37101E−01 | A10 = −1.45250E+00 |
| Surface No. 32 | K = 0.00000E+00 | A4 = 3.19022E−02 | A6 = 3.13557E−02 | A8 = −1.38083E−01 | A10 = 2.70113E−01 |

### (Various Data of Lens System)

TABLE 16
Various data of lens system
Zooming ratio 3.53045

| | Wide angle | Middle | Telephoto |
|---|---|---|---|
| Focal length | 0.9999 | 1.8790 | 3.5303 |
| F-number | 2.90046 | 3.52388 | 4.14665 |
| Field angle | 41.4383 | 24.4983 | 13.5787 |
| Image height | 0.8090 | 0.8750 | 0.8750 |
| Overall length of lens system | 5.4841 | 5.9071 | 7.3458 |
| d2 | 0.0200 | 0.5257 | 1.1960 |
| d12 | 1.1074 | 0.3707 | 0.0606 |
| d25 | 0.2236 | 0.1512 | 0.0836 |
| d27 | 0.0544 | 0.1268 | 0.1944 |
| d29 | 0.2367 | 0.2318 | 0.1027 |
| d31 | 0.4927 | 0.5062 | 0.7049 |
| d35 | 0.6756 | 1.3209 | 2.3294 |
| Entrance pupil position | 1.1110 | 1.7403 | 3.0197 |
| Exit pupil position | −2.5833 | −3.2576 | −4.4717 |
| Front principal point position | 1.7239 | 2.5356 | 3.7633 |
| Back principal point position | 4.4842 | 4.0281 | 3.8156 |

### (Single Lens Data)

TABLE 17
Single lens data

| Lens | Initial surface | Focal length |
|---|---|---|
| 1 | 1 | 4.9099 |
| 2 | 3 | −1.1139 |
| 3 | 5 | −2.1701 |
| 4 | 7 | 3.7754 |
| 5 | 9 | 2.4890 |
| 6 | 11 | −3.2104 |
| 7 | 14 | 1.4002 |
| 8 | 16 | −4.5136 |
| 9 | 18 | 1.8694 |
| 10 | 20 | −1.3056 |
| 11 | 22 | −2.0548 |
| 12 | 24 | 1.9372 |
| 13 | 26 | −14.8217 |
| 14 | 28 | 1.1121 |
| 15 | 30 | −1.8235 |
| 16 | 32 | −2.0283 |
| 17 | 34 | 1.9823 |

### (Data of Zoom Lens Group)

TABLE 18
Data of zoom lens group

| | | | Overall | | |
|---|---|---|---|---|---|
| Lens | Initial | Focal | length | Front principal | Back principal |
| group | surface | length | of lens | point position | point position |
| 1 | 1 | 4.90991 | 0.26290 | −0.00754 | 0.09019 |
| 2 | 3 | −0.98194 | 0.97670 | 0.08621 | 0.31030 |
| 3 | 13 | 2.32234 | 0.89660 | −0.35104 | 0.01861 |
| 4 | 26 | −14.82170 | 0.04040 | 0.15225 | 0.16439 |
| 5 | 28 | 1.11212 | 0.26290 | 0.07609 | 0.16290 |
| 6 | 30 | −1.82346 | 0.04040 | 0.03358 | 0.05253 |
| 7 | 32 | 152.38809 | 0.19370 | −1.47557 | −1.36907 |

### (Magnification of Zoom Lens Group)

TABLE 19
Magnification of zoom lens group

| Lens group | Initial surface | Wide angle | Middle | Telephoto |
|---|---|---|---|---|
| 1 | 1 | 0.00000 | 0.00000 | 0.00000 |
| 2 | 3 | −0.26909 | −0.31239 | −0.39706 |
| 3 | 13 | −6.70035 | 6.68126 | 4.04202 |
| 4 | 26 | −8.20108 | 0.50765 | 0.64442 |
| 5 | 28 | −0.00822 | −0.17753 | −0.25835 |
| 6 | 30 | 1.70023 | 2.07379 | 2.76152 |
| 7 | 32 | 0.98531 | 0.98108 | 0.97445 |

### Numerical Example 4

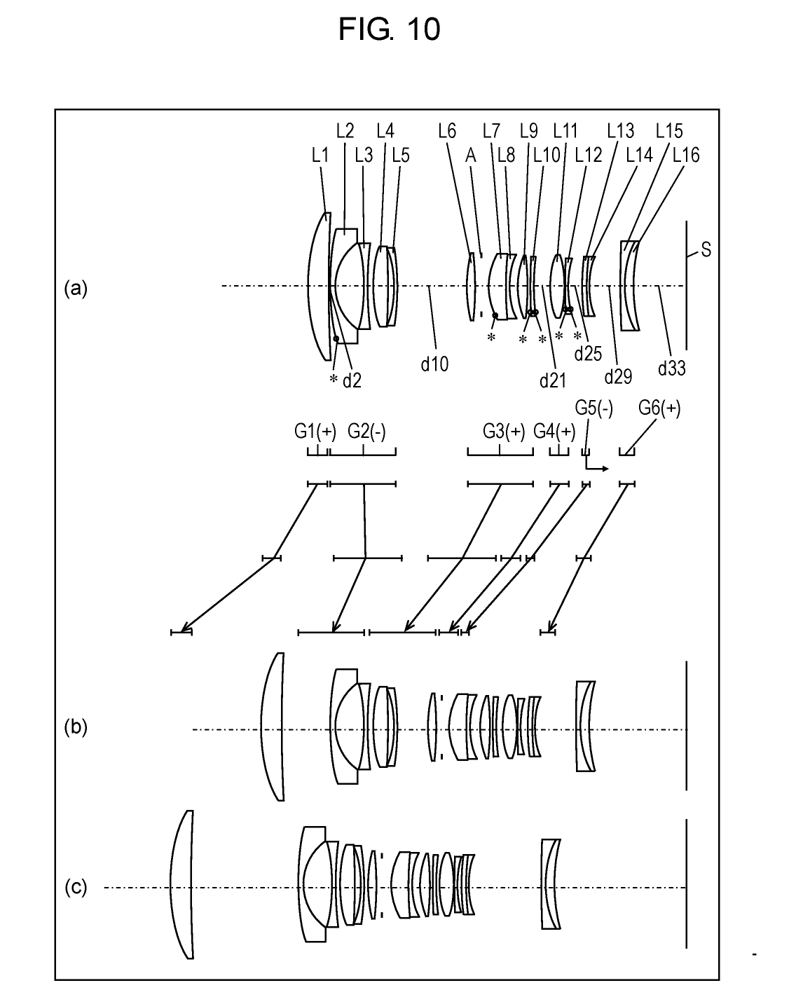

The zoom lens system according to Numerical Example 4 corresponds to the fourth exemplary embodiment (FIG. 10).

Table 20 shows the surface data of the zoom lens system, Table 21 shows the aspherical data, Table 22 shows various data of the lens system, Table 23 shows the single lens data, Table 24 shows the data of the zoom lens group, and Table 25 shows the magnification of the zoom lens group.

### (Surface Data)

TABLE 20
Surface data

| Surface number | r | d | nd | νd |
|---|---|---|---|---|
| Object surface | ∞ | | | |
| 1 | 2.66610 | 0.28310 | 1.59349 | 67.0 |
| 2 | 18.34670 | Variable | | |
| 3* | 5.77300 | 0.06470 | 1.83400 | 37.3 |
| 4 | 0.80190 | 0.40100 | | |
| 5 | −2.48420 | 0.04850 | 1.78590 | 43.9 |
| 6 | 6.89550 | 0.06100 | | |
| 7 | 2.09730 | 0.22250 | 1.92110 | 22.4 |
| 8 | −4.38380 | 0.06540 | | |
| 9 | −1.59700 | 0.04450 | 1.71300 | 53.9 |
| 10 | −6.23910 | Variable | | |
| 11 | 2.33180 | 0.09360 | 1.84666 | 23.8 |
| 12 | −16.04820 | 0.09520 | | |
| 13 (Diaphragm) | ∞ | 0.10970 | | |
| 14* | 0.85030 | 0.22810 | 1.49700 | 81.6 |
| 15 | 4.42720 | 0.00040 | 1.56732 | 42.8 |
| 16 | 4.42720 | 0.04850 | 1.90682 | 21.2 |
| 17 | 0.99590 | 0.12460 | | |
| 18 | 1.27360 | 0.12380 | 1.43700 | 95.1 |
| 19 | −8.27040 | 0.04550 | | |
| 20* | −31.78900 | 0.04850 | 1.75550 | 45.6 |
| 21* | 2.97770 | Variable | | |
| 22 | 1.08750 | 0.20220 | 1.59349 | 67.0 |
| 23 | −1.50590 | 0.00850 | | |
| 24* | 4.22410 | 0.04450 | 1.69384 | 53.1 |
| 25* | 2.41670 | Variable | | |
| 26 | 4.52160 | 0.06040 | 1.94595 | 18.0 |
| 27 | 3.63360 | 0.00040 | 1.56732 | 42.8 |
| 28 | 3.63360 | 0.04850 | 1.82027 | 29.7 |
| 29 | 1.15620 | Variable | | |
| 30 | 9.04170 | 0.05660 | 1.62588 | 35.7 |
| 31 | 1.33010 | 0.00040 | 1.56732 | 42.8 |
| 32 | 1.33010 | 0.14090 | 1.94595 | 18.0 |
| 33 | 4.05720 | Variable | | |
| Image plane | ∞ | | | |

### (Aspherical Data)

TABLE 21
Aspherical data

| | | | | | |
|---|---|---|---|---|---|
| Surface No. 3 | K = 0.00000E+00 | A4 = 4.36514E−02 | A6 = −2.86101E−02 | A8 = 2.02296E−02 | A10 = −7.08324E−03 |
| Surface No. 14 | K = 0.00000E+00 | A4 = −1.10121E−01 | A6 = −1.32772E−01 | A8 = −5.63640E−02 | A10 = −1.06519E+00 |
| Surface No. 20 | K = 0.00000E+00 | A4 = 3.81790E−02 | A6 = 1.34071E−01 | A8 = −1.85316E−01 | A10 = 8.64635E−01 |
| Surface No. 21 | K = 0.00000E+00 | A4 = 1.59397E−02 | A6 = 3.88877E−02 | A8 = 4.85004E−01 | A10 = −5.69863E−01 |
| Surface No. 24 | K = 0.00000E+00 | A4 = −2.95790E−01 | A6 = −3.43361E−01 | A8 = 2.56315E−01 | A10 = −6.98605E−01 |
| Surface No. 25 | K = 0.00000E+00 | A4 = 9.62991E−02 | A6 = 1.46633E−01 | A8 = −6.72892E−01 | A10 = 1.86700E+00 |

### (Various Data of Lens System)

TABLE 22
Various data of lens system
Zooming ratio 3.52998

| | Wide angle | Middle | Telephoto |
|---|---|---|---|
| Focal length | 1.0002 | 1.8794 | 3.5307 |
| F-number | 2.90539 | 3.52691 | 4.14860 |
| Field angle | 41.6215 | 24.7096 | 13.6666 |
| Image height | 0.8090 | 0.8750 | 0.8750 |
| Overall length of lens system | 5.2032 | 5.8510 | 7.0964 |
| d2 | 0.0202 | 0.6986 | 1.4728 |
| d10 | 0.9743 | 0.4166 | 0.0595 |
| d21 | 0.2190 | 0.0774 | 0.0470 |
| d25 | 0.1850 | 0.0985 | 0.0419 |
| d29 | 0.4139 | 0.5728 | 0.9938 |
| d33 | 0.7191 | 1.3154 | 1.8092 |
| Entrance pupil position | 1.1114 | 2.1249 | 3.8113 |
| Exit pupil position | −2.4007 | −2.9455 | −3.9045 |
| Front principal point position | 1.6950 | 2.8054 | 4.1503 |
| Back principal point position | 4.2030 | 3.9717 | 3.5657 |

### (Single Lens Data)

TABLE 23
Single lens data

| Lens | Initial surface | Focal length |
|---|---|---|
| 1 | 1 | 5.2209 |
| 2 | 3 | −1.1233 |
| 3 | 5 | −2.3185 |
| 4 | 7 | 1.5659 |
| 5 | 9 | −3.0225 |
| 6 | 11 | 2.4103 |
| 7 | 14 | 2.0737 |
| 8 | 16 | −1.4266 |
| 9 | 18 | 2.5355 |
| 10 | 20 | −3.6016 |
| 11 | 22 | 1.0958 |
| 12 | 24 | −8.2233 |
| 13 | 26 | −20.2280 |
| 14 | 28 | −2.0858 |
| 15 | 30 | −2.4988 |
| 16 | 32 | 2.0407 |

### (Data of Zoom Lens Group)

TABLE 24
Data of zoom lens group

| | | | Overall | Front | |
|---|---|---|---|---|---|
| Lens | Initial | Focal | length | principal point | Back principal |
| group | surface | length | of lens | position | point position |
| 1 | 1 | 5.22090 | 0.28310 | −0.03000 | 0.07662 |
| 2 | 3 | −0.97431 | 0.90760 | 0.08407 | 0.28646 |
| 3 | 11 | 2.22009 | 0.91790 | −0.34253 | 0.00744 |
| 4 | 22 | 1.23885 | 0.25520 | 0.03274 | 0.12517 |
| 5 | 26 | −1.89869 | 0.10930 | 0.08009 | 0.13053 |
| 6 | 30 | 12.20937 | 0.19790 | −0.20103 | −0.10501 |

### (Magnification of Zoom Lens Group)

TABLE 25
Magnification of zoom lens group

| Lens group | Initial surface | Wide angle | Middle | Telephoto |
|---|---|---|---|---|
| 1 | 1 | 0.00000 | 0.00000 | 0.00000 |
| 2 | 3 | −0.24755 | −0.29910 | −0.39235 |
| 3 | 11 | −8.94028 | 8.56696 | 4.22560 |
| 4 | 22 | 0.05594 | −0.07471 | −0.17922 |
| 5 | 26 | 1.68882 | 2.16769 | 2.75237 |
| 6 | 30 | 0.91623 | 0.86739 | 0.82691 |

### Numerical Example 5

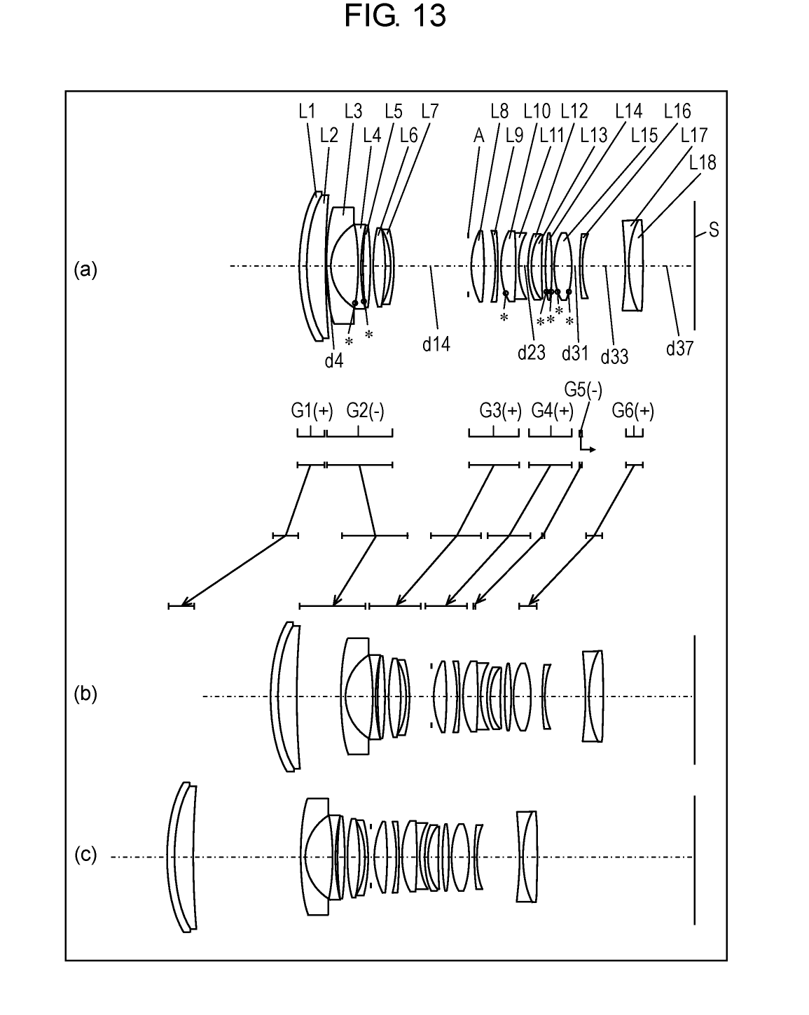

The zoom lens system according to Numerical Example 5 corresponds to the fifth exemplary embodiment (FIG. 13).

Table 26 shows the surface data of the zoom lens system, Table 27 shows the aspherical data, Table 28 shows various data of the lens system, Table 29 shows the single lens data, Table 30 shows the data of the zoom lens group, and Table 31 shows the magnification of the zoom lens group.

### (Surface Data)

TABLE 26
Surface data

| Surface number | r | d | nd | νd |
|---|---|---|---|---|
| Object surface | ∞ | | | |
| 1 | 2.49900 | 0.08090 | 1.84666 | 23.8 |
| 2 | 2.19890 | 0.00040 | 1.56732 | 42.8 |
| 3 | 2.19890 | 0.28310 | 1.59181 | 58.3 |
| 4 | 13.81950 | Variable | | |
| 5 | 3.80320 | 0.06570 | 1.83399 | 37.4 |
| 6 | 0.73860 | 0.38140 | | |
| 7* | −3.02460 | 0.04920 | 1.74000 | 31.7 |
| 8* | 2.35780 | 0.02770 | | |
| 9 | 4.92940 | 0.09140 | 1.84666 | 23.8 |
| 10 | −12.70750 | 0.03170 | | |
| 11 | 2.70960 | 0.14740 | 1.84666 | 23.8 |
| 12 | −3.47150 | 0.08500 | | |
| 13 | −1.16660 | 0.04510 | 1.72950 | 51.4 |
| 14 | −3.11300 | Variable | | |
| 15 (Diaphragm) | ∞ | 0.06070 | | |
| 16 | 1.56380 | 0.16410 | 1.84666 | 23.8 |
| 17 | −5.04650 | 0.14780 | | |
| 18 | −2.70370 | 0.03470 | 1.62588 | 35.7 |
| 19 | −55.41420 | 0.04140 | | |
| 20* | 1.06090 | 0.21540 | 1.49710 | 81.6 |
| 21 | −7.00020 | 0.00040 | 1.56732 | 42.8 |
| 22 | −7.00020 | 0.04850 | 1.92286 | 20.9 |
| 23 | 1.49210 | Variable | | |
| 24 | 1.89430 | 0.04850 | 1.75520 | 27.5 |
| 25 | 0.81290 | 0.00040 | 1.56732 | 42.8 |
| 26 | 0.81290 | 0.11580 | 1.48749 | 70.4 |
| 27 | 2.34740 | 0.08090 | | |
| 28* | 4.05120 | 0.07310 | 1.72916 | 54.7 |
| 29* | −12.86140 | 0.04210 | | |
| 30* | 1.27030 | 0.24270 | 1.56908 | 71.3 |
| 31* | −1.38430 | Variable | | |
| 32 | 4.72270 | 0.03020 | 1.89800 | 34.0 |
| 33 | 1.20000 | Variable | | |
| 34 | −4.61630 | 0.04510 | 1.72950 | 51.4 |
| 35 | 1.59080 | 0.00040 | 1.56732 | 42.8 |
| 36 | 1.59080 | 0.20210 | 1.92286 | 20.9 |
| 37 | −20.28080 | Variable | | |
| Image plane | ∞ | | | |

### (Aspherical Data)

TABLE 27
Aspherical data

| | | | | | |
|---|---|---|---|---|---|
| Surface No. 7 | K = 0.00000E+00 | A4 = −1.79721E−02 | A6 = 5.94158E−03 | A8 = 2.88761E−01 | A10 = −4.57961E−01 |
| Surface No. 8 | K = 0.00000E+00 | A4 = −1.72667E−01 | A6 = −1.16897E−01 | A8 = 5.34284E−01 | A10 = −1.34172E+00 |
| Surface No. 20 | K = 0.00000E+00 | A4 = −8.42561E−02 | A6 = −1.54214E−01 | A8 = 9.80791E−02 | A10 = −3.26624E−01 |
| Surface No. 28 | K = 0.00000E+00 | A4 = −8.55733E−03 | A6 = 8.02095E−03 | A8 = −1.14474E−02 | A10 = −3.82716E−03 |
| Surface No. 29 | K = 0.00000E+00 | A4 = 1.21660E−02 | A6 = −1.97467E−02 | A8 = 2.73509E−02 | A10 = 1.37017E−01 |
| Surface No. 30 | K = 0.00000E+00 | A4 = −1.89711E−01 | A6 = −4.36158E−02 | A8 = 5.00035E−01 | A10 = −3.38437E+00 |
| Surface No. 31 | K = 0.00000E+00 | A4 = 9.65448E−02 | A6 = −9.24389E−02 | A8 = 5.00403E−02 | A10 = −2.43708E+00 |

### (Various Data of Lens System)

TABLE 28
Various data of lens system
Zooming ratio 3.53183

| | Wide angle | Middle | Telephoto |
|---|---|---|---|
| Focal length | 1.0002 | 1.8796 | 3.5324 |
| F-number | 2.90219 | 3.52514 | 4.14462 |
| Field angle | 41.9126 | 24.8119 | 13.5775 |
| Image height | 0.8090 | 0.8750 | 0.8750 |
| Overall length of lens system | 5.5956 | 5.9630 | 7.4451 |
| d4 | 0.0200 | 0.6205 | 1.5039 |
| d14 | 1.0854 | 0.3291 | 0.0606 |
| d23 | 0.1430 | 0.0878 | 0.0631 |
| d31 | 0.1115 | 0.1768 | 0.0780 |
| d33 | 0.6160 | 0.5557 | 0.6181 |
| d37 | 0.7359 | 1.3089 | 2.2365 |
| Entrance pupil position | 1.1648 | 1.9579 | 3.8763 |
| Exit pupil position | −2.8947 | −3.2959 | −4.2299 |
| Front principal point position | 1.8195 | 2.7659 | 4.4599 |
| Back principal point position | 4.5955 | 4.0834 | 3.9127 |

### (Single Lens Data)

TABLE 29
Single lens data

| Lens | Initial surface | Focal length |
|---|---|---|
| 1 | 1 | −24.6769 |
| 2 | 3 | 4.3790 |
| 3 | 5 | −1.1099 |
| 4 | 7 | −1.7835 |
| 5 | 9 | 4.2049 |
| 6 | 11 | 1.8173 |
| 7 | 13 | −2.5829 |
| 8 | 16 | 1.4263 |
| 9 | 18 | −4.5426 |
| 10 | 20 | 1.8699 |
| 11 | 22 | −1.3291 |
| 12 | 24 | −1.9226 |
| 13 | 26 | 2.4893 |
| 14 | 28 | 4.2328 |
| 15 | 30 | 1.2040 |
| 16 | 32 | −1.7988 |
| 17 | 34 | −1.6168 |
| 18 | 36 | 1.6055 |

### (Data of Zoom Lens Group)

TABLE 30
Data of zoom lens group

| | | | Overall | Front | Back |
|---|---|---|---|---|---|
| Lens | Initial | | length | principal | principal |
| group | surface | Focal length | of lens | point position | point position |
| 1 | 1 | 5.43052 | 0.36440 | −0.07938 | 0.06656 |
| 2 | 5 | −0.92706 | 0.92460 | 0.09354 | 0.30202 |
| 3 | 15 | 2.25571 | 0.71300 | −0.39433 | −0.04175 |
| 4 | 24 | 1.08993 | 0.60350 | 0.33328 | 0.49777 |
| 5 | 32 | −1.79882 | 0.03020 | 0.02142 | 0.03564 |
| 6 | 34 | 100.95042 | 0.24760 | 0.92797 | 1.05186 |

### (Magnification of Zoom Lens Group)

TABLE 31
Magnification of zoom lens group

| Lens group | Initial surface | Wide angle | Middle | Telephoto |
|---|---|---|---|---|
| 1 | 1 | 0.00000 | 0.00000 | 0.00000 |
| 2 | 5 | −0.22655 | −0.26551 | −0.35544 |
| 3 | 15 | −11.56591 | 4.29537 | 3.17581 |
| 4 | 24 | 0.03864 | −0.14495 | −0.21934 |
| 5 | 32 | 1.81762 | 2.10425 | 2.66503 |
| 6 | 34 | 1.00067 | 0.99499 | 0.98580 |

### Numerical Example 6

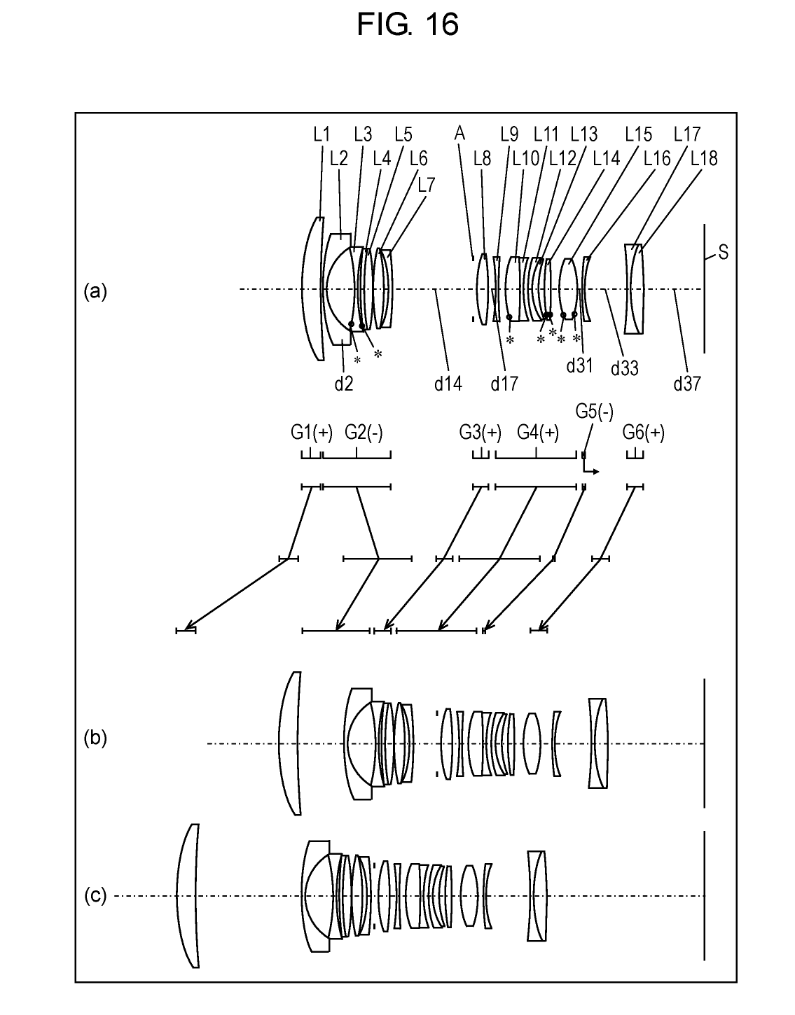

The zoom lens system according to Numerical Example 6 corresponds to the sixth exemplary embodiment (FIG. 16).

Table 32 shows the surface data of the zoom lens system, Table 33 shows the aspherical data, Table 34 shows various data of the lens system, Table 35 shows the single lens data, Table 36 shows the data of the zoom lens group, and Table 37 shows the magnification of the zoom lens group.

### (Surface Data)

TABLE 32
Surface data

| Surface number | r | d | nd | νd |
|---|---|---|---|---|
| Object surface | ∞ | | | |
| 1 | 2.40710 | 0.26670 | 1.58913 | 61.3 |
| 2 | 11.68770 | Variable | | |
| 3 | 2.51340 | 0.06570 | 1.83399 | 37.4 |
| 4 | 0.69200 | 0.40070 | | |
| 5* | −1.98270 | 0.04920 | 1.72916 | 54.7 |
| 6* | 1.84520 | 0.03900 | | |
| 7 | 5.24030 | 0.04050 | 1.69895 | 30.0 |
| 8 | 5.38200 | 0.00040 | 1.56732 | 42.8 |
| 9 | 5.38200 | 0.10410 | 1.83918 | 23.9 |
| 10 | −4.45510 | 0.01050 | | |
| 11 | 2.05460 | 0.14120 | 1.83441 | 37.3 |
| 12 | −4.44570 | 0.06940 | | |
| 13 | −1.45330 | 0.04510 | 1.72000 | 43.9 |
| 14 | −7.82320 | Variable | | |
| 15 (Diaphragm) | ∞ | 0.06070 | | |
| 16 | 1.50130 | 0.16410 | 1.84666 | 23.8 |
| 17 | −5.35150 | Variable | | |
| 18 | −4.15640 | 0.04050 | 1.62000 | 62.2 |
| 19 | 7.97150 | 0.08560 | | |
| 20* | 1.10460 | 0.21950 | 1.49710 | 81.6 |
| 21 | −5.31560 | 0.00040 | 1.56732 | 42.8 |
| 22 | −5.31560 | 0.04850 | 1.92286 | 20.9 |
| 23 | 1.54630 | 0.06040 | | |
| 24 | 1.59230 | 0.04850 | 1.75520 | 27.5 |
| 25 | 0.75660 | 0.00040 | 1.56732 | 42.8 |
| 26 | 0.75660 | 0.11660 | 1.49700 | 81.4 |
| 27 | 1.96510 | 0.08090 | | |
| 28* | 3.39710 | 0.07250 | 1.73351 | 51.2 |
| 29* | −28.95720 | 0.13060 | | |
| 30* | 1.23680 | 0.24270 | 1.56908 | 71.3 |
| 31* | −1.55180 | Variable | | |
| 32 | 4.07620 | 0.02830 | 1.92110 | 22.4 |
| 33 | 1.15590 | Variable | | |
| 34 | −3.60590 | 0.04510 | 1.74100 | 52.6 |
| 35 | 1.56520 | 0.00040 | 1.56732 | 42.8 |
| 36 | 1.56520 | 0.19060 | 1.94595 | 18.0 |
| 37 | −8.83510 | Variable | | |
| Image plane | ∞ | | | |

### (Aspherical Data)

TABLE 33
Aspherical data

| | | | | | |
|---|---|---|---|---|---|
| Surface No. 5 | K = 0.00000E+00 | A4 = −1.86405E−02 | A6 = −1.61755E−01 | A8 = 1.68047E−01 | A10 = −5.73845E−02 |
| Surface No. 6 | K = 0.00000E+00 | A4 = −1.93225E−01 | A6 = −1.56643E−01 | A8 = 2.56117E−01 | A10 = −2.01750E−01 |
| Surface No. 20 | K = 0.00000E+00 | A4 = −8.19989E−02 | A6 = −1.04888E−01 | A8 = −4.07540E−02 | A10 = −1.01224E−01 |
| Surface No. 28 | K = 0.00000E+00 | A4 = −6.10231E−03 | A6 = 6.63740E−03 | A8 = −9.01926E−02 | A10 = −6.57010E−02 |
| Surface No. 29 | K = 0.00000E+00 | A4 = 1.35716E−02 | A6 = −1.59678E−02 | A8 = 2.67602E−02 | A10 = −2.50687E−01 |
| Surface No. 30 | K = 0.00000E+00 | A4 = −1.79647E−01 | A6 = −3.08265E−02 | A8 = 3.30959E−01 | A10 = −2.94349E+00 |
| Surface No. 31 | K = 0.00000E+00 | A4 = 9.07754E−02 | A6 = −1.25628E−01 | A8 = 2.32862E−01 | A10 = −2.70617E+00 |

### (Various Data of Lens System)

TABLE 34
Various data of lens system
Zooming ratio 3.53156

| | Wide angle | Middle | Telephoto |
|---|---|---|---|
| Focal length | 1.0000 | 1.8794 | 3.5317 |
| F-number | 2.90233 | 3.5218 | 4.14913 |
| Field angle | 41.9340 | 24.7447 | 13.5808 |
| Image height | 0.8090 | 0.8750 | 0.8750 |
| Overall length of lens system | 5.6796 | 6.0000 | 7.4521 |
| d2 | 0.0202 | 0.6493 | 1.5079 |
| d14 | 1.1670 | 0.3411 | 0.0606 |
| d17 | 0.0998 | 0.0947 | 0.0809 |
| d31 | 0.0806 | 0.1832 | 0.0785 |
| d33 | 0.5962 | 0.5234 | 0.6490 |
| d37 | 0.8465 | 1.3388 | 2.2052 |
| Entrance pupil position | 1.1073 | 1.9522 | 3.8807 |
| Exit pupil position | −3.0133 | −3.4228 | −4.4083 |
| Front principal point position | 1.7755 | 2.7999 | 4.5838 |
| Back principal point position | 4.6795 | 4.1206 | 3.9204 |

### (Single Lens Data)

TABLE 35
Single lens data

| Lens | Initial surface | Focal length |
|---|---|---|
| 1 | 1 | 5.0914 |
| 2 | 3 | −1.1641 |
| 3 | 5 | −1.3037 |
| 4 | 7 | 254.8024 |
| 5 | 9 | 2.9186 |
| 6 | 11 | 1.7009 |
| 7 | 13 | −2.4864 |
| 8 | 16 | 1.4001 |
| 9 | 18 | −4.4007 |
| 10 | 20 | 1.8609 |
| 11 | 22 | −1.2936 |
| 12 | 24 | −1.9578 |
| 13 | 26 | 2.3986 |
| 14 | 28 | 4.1490 |
| 15 | 30 | 1.2488 |
| 16 | 32 | −1.7598 |
| 17 | 34 | −1.4675 |
| 18 | 36 | 1.4183 |

### (Data of Zoom Lens Group)

TABLE 36
Data of zoom lens group

| | | | Overall | Front | |
|---|---|---|---|---|---|
| Lens | Initial | Focal | length | principal point | Back principal |
| group | surface | length | of lens | position | point position |
| 1 | 1 | 5.09137 | 0.26670 | −0.04307 | 0.05757 |
| 2 | 3 | −0.92711 | 0.96580 | 0.09432 | 0.30835 |
| 3 | 15 | 1.40010 | 0.22480 | 0.08038 | 0.15463 |
| 4 | 18 | 1.60431 | 1.14710 | 0.92247 | 1.30322 |
| 5 | 32 | −1.75980 | 0.02830 | 0.02066 | 0.03416 |
| 6 | 34 | 28.91756 | 0.23610 | 0.48308 | 0.60152 |

### (Magnification of Zoom Lens Group)

TABLE 37
Magnification of zoom lens group

| Lens group | Initial surface | Wide angle | Middle | Telephoto |
|---|---|---|---|---|
| 1 | 1 | 0.00000 | 0.00000 | 0.00000 |
| 2 | 3 | −0.24140 | −0.28868 | −0.39403 |
| 3 | 15 | −0.84565 | −1.60270 | −2.02691 |
| 4 | 18 | 0.51819 | 0.38556 | 0.33642 |
| 5 | 32 | 1.88826 | 2.14144 | 2.75722 |
| 6 | 34 | 0.98335 | 0.96631 | 0.93634 |

The following Table 38 shows the corresponding values to the individual conditions in the zoom lens systems of each of Numerical Examples.

### (Values Corresponding to Conditions)

TABLE 38

| | | Numerical Example | | | | | |
|---|---|---|---|---|---|---|---|
| Condition | | 1 | 2 | 3 | 4 | 5 | 6 |
| (1) | α2f/Wf | 2.17 | 2.15 | 2.32 | 2.22 | 2.26 | 1.60 |
| (2) | G1f/Wf | 5.21 | 5.52 | 4.91 | 5.22 | 5.43 | 5.09 |
| (3) | G1D/Wf | 0.28 | 0.36 | 0.26 | 0.28 | 0.36 | 0.27 |
| (4) | \| G2f/Wf \| | 0.92 | 0.92 | 0.98 | 0.97 | 0.93 | 0.93 |
| (5) | \| G1f/G2f \| | 5.66 | 5.98 | 5.00 | 5.36 | 5.86 | 5.49 |
| (6) | G2LD/Wf | 0.04 | 0.04 | 0.04 | 0.04 | 0.05 | 0.04 |

The zoom lens system according to the present disclosure is applicable to a digital still camera, a digital video camera, a camera for a mobile phone device, a camera for a PDA (Personal Digital Assistance), a surveillance camera in a surveillance system, a Web camera, a vehicle-mounted camera or the like. In particular, the present disclosure is suitable for a photographing optical system where high image quality is required, like a digital still camera system or a digital video camera system.

What is claimed is:

1. A zoom lens system comprising, from an object side to an image side:
a first lens group having positive power;
a second lens group including four or more lens elements and having negative power; and
a subsequent lens group including at least four lens groups which include a third lens group,
wherein
the third lens group includes four or more lens elements including at least two or more positive lens elements,
the subsequent lens group includes two or more positive lens groups,
the first lens group, the second lens group and a most image side lens group which disposed closest to the image side move with respect to an image in zooming from a wide angle end to a telephoto end,
a lens group disposed between the third lens group and an image plane is moved along an optical axis as a focusing lens group in focusing from an infinity in-focus condition to a close-object in-focus condition, and the following conditions (1), (2), and (5) are simultaneously satisfied:
0.1<α2f/W<4.0 (1)
2.7<G1f/Wf<14.0 (2)
2.0<|G1f/G2f|<8.0 (5)
where
Wf is a focal length of an entire system at the wide angle end,
α2f is a focal length of a lens group having a second highest power out of the two or more positive lens groups included in the subsequent lens group,
G1f is a focal length of the first lens group, and
G2f is a focal length of the second lens group.

2. The zoom lens system according to claim 1, wherein
the subsequent lens group includes an image blur compensation lens group that optically compensates image blur by moving any lens group in the subsequent lens group or a part of any lens group in the subsequent lens group in a direction perpendicular to the optical axis.

3. The zoom lens system according to claim 2, wherein
the image blur compensation lens group includes one lens element.

4. The zoom lens system according to claim 1, wherein
the focusing lens group includes two or less lens elements.

5. The zoom lens system according to claim 1, wherein
a lens element disposed closest to the image side in the subsequent lens group has positive power.

6. The zoom lens system according to claim 1, wherein
a lens element disposed closest to the object side in the subsequent lens group has a convex surface at the object side.

7. The zoom lens system according to claim 1, wherein
the third lens group has an aperture diaphragm.

8. The zoom lens system according to claim 1, wherein
the third lens group moves with respect to the image plane in zooming from the wide angle end to the telephoto end.

9. The zoom lens system according to claim 1, wherein
the subsequent lens group moves with respect to the image plane in zooming from the wide angle end to the telephoto end.

10. The zoom lens system according to claim 1, wherein the following condition (3) is satisfied:
0.1<G1D/Wf<1.0 (3)
where
G1D is a thickness of a lens in the first lens group G1 on the optical axis.

11. The zoom lens system according to claim 1, wherein the following condition (4) is satisfied:
0.5<|G2f/Wf|<1.5 (4)
where
G2f is a focal length of the second lens group G2.

12. The zoom lens system according to claim 1, wherein the following condition (5) is satisfied:
2.0<|G1f/G2f|<8.0 (5).

13. The zoom lens system according to claim 1, wherein
the four or more lens elements included in the second lens group satisfy the following condition (6):
0.02<G2LD/Wf<1.0 (6)
where
G2LD is a thickness of a thinnest lens element out of the four or more lens elements included in the second lens group G2.

14. An interchangeable lens device comprising:
a zoom lens system; and
a lens mount section connectable to a camera body including an image sensor that receives an optical image formed by the zoom lens system and converts the received image into an electric image signal,
wherein
the zoom lens system includes, from an object side to an image side:
a first lens group including two or less lens elements and having positive power;
a second lens group including four or more lens elements and having negative power; and
a subsequent lens group including at least three lens groups which include a third lens group, wherein
the subsequent lens group includes two or more positive lens groups,
the first lens group and the second lens group move with respect to an image in zooming from a wide angle end to a telephoto end,
a lens group disposed between the third lens group and an image plane is moved along an optical axis as a focusing lens group in focusing from an infinity in-focus condition to a close-object in-focus condition, and
the following conditions (1) and (2) are simultaneously satisfied:
0.1<α2f/Wf<4.0 (1)
2.7<G1f/Wf<14.0 (2)
where
Wf is a focal length of an entire system at the wide angle end,
α2f is a focal length of a lens group having a second highest power out of the two or more positive lens groups included in the subsequent lens group, and
G1f is a focal length of the first lens group.

15. A camera system comprising:
an interchangeable lens device; and
a camera body that is detachably connected to the interchangeable lens device through a camera mount section and includes an image sensor which receives an optical image formed by a zoom lens system and converts the received image into an electric image signal,
wherein
the interchangeable lens device includes:
the zoom lens system; and
a lens mount section that is connectable to the camera body,
the zoom lens system includes, from an object side to an image side:
a first lens group including two or less lens elements and having positive power;
a second lens group including four or more lens elements and having negative power; and
a subsequent lens group including at least three lens groups which include a third lens group,
the subsequent lens group includes two or more positive lens groups,
the first lens group and the second lens group move with respect to an image in zooming from a wide angle end to a telephoto end,
a lens group disposed between the third lens group and an image plane is moved along an optical axis as a focusing lens group in focusing from an infinity in-focus condition to a close-object in-focus condition, and
the following conditions (1) and (2) are simultaneously satisfied:
0.1<α2f/Wf<4.0 (1)
2.7<G1f/Wf<14.0 (2)
where
Wf is a focal length of an entire system at(the?) the wide angle end,
α2f is a focal length of a lens group having a second highest power out of the two or more positive lens groups included in the subsequent lens group, and
G1f is a focal length of the first lens group.
